(19) United States
(12) Patent Application Publication
(10) Pub. No.: US 2019/0312448 A1
(43) Pub. Date: Oct. 10, 2019

(54) ELECTRONIC DEVICE AND ELECTRONIC DEVICE CONTROL METHOD

(71) Applicant: SAMSUNG ELECTRONICS CO., LTD., Suwon-si, Gyeonggi-do (KR)

(72) Inventors: Hoyeong LIM, Suwon-si, Gyeonggi-do (KR); Duhyun KIM, Yongin-si, Gyeonggi-do (KR); Yongseung YI, Seoul (KR); Dongil SON, Hwaseong-si, Gyeonggi-do (KR)

(21) Appl. No.: 16/314,935

(22) PCT Filed: Nov. 16, 2016
(86) PCT No.: PCT/KR2016/013171

§ 371 Date: Jan. 3, 2019

(30) Foreign Application Priority Data
Aug. 18, 2016 (KR) 10-2016-0104850

(51) Int. Cl. H02J 7/00; G05F 3/02; G06F 1/26

(52) U.S. Cl. CPC H02J 7/0047; H02J 7/0027; G06F 1/266; G05F 3/02; H02J 7/007

(57) ABSTRACT

An electronic device is disclosed. The disclosed electronic device comprises: a connector, which includes a first terminal and a second terminal and can be coupled to an external electronic device; a battery for supplying power to the electronic device; and a first switch connected to the first terminal, and a second switch connected to the second terminal, wherein the electronic device can be set such that the first switch and/or the second switch are shorted, on the basis of a state in which the electronic device is off and/or a state in which a voltage of the battery is a preset voltage or lower.

### TECHNICAL FIELD

Various embodiments of the present disclosure relate to an electronic device and power supply system and, in particular, to a method for supplying power at a power level difficult to secure operation of the electronic device and an electronic device, power supply system, and power supply method for supporting thereof.

### BACKGROUND ART

The electronic device (e.g., smartphone, tablet personal computer (PC), and notebook computer) is used in various fields because of its convenience and portability. With the diversification of application fields and functionalities of the electronic device, power consumption of the electronic device becomes a key issue.

The consumed power may be charged in various manners. For example, the electronic device may be connected to a socket, a portable supplementary battery, or another electronic device for charging.

### DISCLOSURE OF INVENTION

### Technical Problem

An electronic device with a universal serial bus (USB) 2.0 port such as a Micro USB is designed, when connected to another electronic device via the USB port, to be always power-induced through power terminals. In the case of power charging through a USB TYPE C port such as USB 3.1, however, when two electronic devices are connected via a USB, the power charging begins after the roles of the electronic devices, i.e., power source and power consumer, are determined.

Accordingly, the power charging may not begin at a low power level where a processor or a USB controller of the electronic device is deactivated.

### Solution to Problem

In accordance with an aspect of the present invention, an electronic device includes a connector having a first terminal and a second terminal connectable to an external electronic device, a battery configured to supply power to the electronic device, a first switch connected to the first terminal, and a second switch connected to the second terminal, wherein at least one of the first and second switches is shorted based on at least one of a state where the electronic device powers off and a state where a voltage of the battery is equal to or less than a predetermined voltage.

Preferably, pull-down resistance is produced, if the at least one of the first and second switches is shorted, at the terminal to which the shorted switch is connected.

Preferably, the electronic device further comprises a processor that is electrically connected to the connector and the first and second switches, wherein the processor is configured to control, if the voltage of the battery is equal to or less than the predetermined voltage, the at least one of the first and second switches to be shorted.

Preferably, the electronic device is configured to receive power supply from the external electronic device when the external electronic device is electrically connected via the connector.

Preferably, the connector further includes a third terminal for receiving the power supply from the external electronic device that is electrically connected to the electronic device.

In accordance with another aspect of the present invention, a power supply system includes a first electronic device having a first connector and a second electronic device having a second connector for electrically connecting to the first electronic device, wherein the first electronic device is configured to maintain, if the first electronic device satisfies a predetermined condition, predetermined resistance on at least one of multiple terminals included in the first connector, and the second electronic device is configured to supply, if the first and second electronic devices are electrically connected to each other via the first and second connectors, power to the first electronic device upon detection of the resistance produced on the at least one terminal of the first electronic device.

Preferably, the first electronic device further includes a battery, and the predetermined condition is at least one of a condition where the first electronic device powers off and a condition where voltage of the battery is equal to or less than a predetermined voltage.

Preferably, the first electronic device includes a plurality of terminals included in the first connector and a plurality of switches connected to the plurality of terminals and, if at least one of the plurality of switches is shorted, pull-down resistance is produced on the terminal connected to the shorted switch.

Preferably, the second electronic device is configured to detect the resistance produced on the at least one terminal of the first electronic device based on a voltage value on the at least one of a plurality of terminals included in the second connector.

Preferably, the second electronic device is configured to determine, if a difference of voltage value of at least one of the plurality of terminals included in the second connector is in a predetermined range, that a resistor is connected to the at least one terminal of the first electronic device and supplies power to the first electronic device.

In accordance with another aspect of the present invention, a method for controlling an electronic device including a connector having at least one terminal and at least one switch connected to the at least one terminal includes determining whether the electronic device takes one of roles as a host device for supplying power and a slave device for receiving the power, determining one of a condition where the electronic device power off and a condition where voltage of a battery of the electronic device is equal to or less than a predetermined voltage is satisfied, and shorting, if at least one of the conditions is satisfied, the at least one switch.

Preferably, in the method for controlling the electronic device including the connector having at least one terminal and at least one switch connected to the at least one terminal, shorting the at least one switch includes producing pull-down resistance on the terminal to which the at least one switch is electrically connected.

Preferably, the method for controlling the electronic device including the connector having at least one terminal and at least one switch connected to the at least one terminal further includes receiving, if an external electronic device is electrically connected via the connector, power supply from the external electronic device.

In accordance with another aspect of the present invention, a power supply method of a system including a first electronic device having a first connector and a second electronic device having a second connector for electrically connecting to the first electronic device includes determining whether the first electronic device satisfies a predetermined condition, producing, if the first electronic device satisfies the predetermined condition, predetermined resistance on at least one of a plurality of terminals included in the first connector, and supplying, if the first and second electronic devices are electrically connected to each other via the first and second connectors, power from the second electronic device to the first electronic device upon detection of the resistance produced on the at least one terminal of the first electronic device.

In accordance with still another aspect of the present invention, a persistent recording medium stores instructions for performing a method for controlling an electronic device including a connector having at least one terminal and at least one switch connected to the at least one terminal, the instructions including instructions for determining whether the electronic device takes one of roles as a host device for supplying power and a slave device for receiving the power, determining one of a condition where the electronic device powers off and a condition where voltage of a battery of the electronic device is equal to or less than a predetermined voltage is satisfied, and shorting, if at least one of the conditions is satisfied, the at least one switch.

### Advantageous Effects of Invention

The electronic device of the present invention includes a first terminal, a second terminal, a connector for connection with an external electronic device, a first switch connected to the first terminal, and a second switch connected to the second terminal, and receives, when at least one of the first and second switches is shorted and connected to the external electronic device based on fulfillment of a predetermined condition, power from the external electronic device without setting mutual roles.

### BRIEF DESCRIPTION OF DRAWINGS

FIG. 1 is a diagram for explaining an electronic device in various network environments;

FIG. 2 is a block diagram illustrating a configuration of an electronic device according to various embodiments;

FIG. 3 is a block diagram illustrating a configuration of a program module according to various embodiments.

FIG. 4A is a diagram for explaining a situation where an electronic device is charged by another electronic device according to various embodiments;

FIGS. 4B to 4H are diagrams for explaining a configuration and characteristics of USB Type C connector.

FIG. 5A is a schematic block diagram illustrating a configuration of an electronic device according to various embodiments;

FIGS. 5B and 5C are diagrams for explaining a situation where an electronic device with a USB TYPE C interface receives power supply from another electronic device in a low voltage state according to various embodiments;

FIG. 6 is a flowchart illustrating a method for an electronic device in a low voltage state to receive power supply from another electronic device according to various embodiments;

FIG. 7 is a block diagram for explaining a method for an electronic device in a low voltage state to receive power supply from another electronic device according to various embodiments;

FIG. 8 is a flowchart illustrating a procedure for an electronic device in a power-off state to receive power supply from another electronic device according to various embodiments; and

FIG. 9 is a flowchart illustrating a procedure for an electronic device in a power-off or low voltage state to receive power supply from another electronic device according to various embodiments.

### MODE FOR THE INVENTION

Various embodiments of the present disclosure are described in detail with reference to accompanying drawings. The embodiments and terms used herein are not intended to limit the technology disclosed in specific forms and should be understood to include various modifications, equivalents, and/or alternatives to corresponding embodiments. In the drawings, similar reference numbers are used to indicate similar constituent elements. As used herein, singular forms are intended to include the plural forms as well, unless the context clearly indicates otherwise.

In the present disclosure, the expression “A or B” or “at least one of A and/or B” is intended to include any possible combination of enumerated items. In the present disclosure, expressions such as “1^{st}” or “first,” “2^{nd}” or “second”, etc. may modify various components regardless of the order and/or the importance but do not limit corresponding components. When it is mentioned that a (first) component is “connected” to or “accessed” by another (second) component, it may be understood that the component is directly connected to or accessed by the other component or that still other (third) component is interposed between the two components.

In the present disclosure, the expression “configured to ˜” may be interchangeably used with the expressions “suitable for ˜”, “having a capability of ˜”, “changed to ˜”, “made to ˜”, “capable of ˜”, and “designed for” in hardware or software. The expression “device configured to ˜” may denote that the device is “capable of ˜” with other devices or components. For example, a “processor configured to (or set to) perform A, B, and C” may mean a dedicated processor (e.g., an embedded processor) for performing a corresponding operation or a general-purpose processor (e.g., a central processing unit (CPU) or an application processor (AP)) which executes corresponding operations by executing one or more software programs which are stored in a memory device.

According to various embodiments of the present disclosure, an electronic device may include at least one of a smart phone, a tablet Personal Computer (PC), a mobile phone, a video phone, an e-book reader, a desktop PC, a laptop PC, a netbook computer, a workstation, a server, a Personal Digital Assistant (PDA), a portable Multimedia Player (PMP), an MP3 player, a medical device, a camera, and a wearable device. The wearable device may include at least one of an appcessory type device (e.g. a watch, a ring, a bracelet, an anklet, a necklace, glasses, contact lens, and Head-Mounted-Device (HMD), a textile or clothes-integrated device (e.g., electronic clothes), a body-attached device (e.g., skin pad and tattoo), and a bio-implemented circuit. According to various embodiments, the electronic device may include at least one of television (TV), a Digital Video Disk (DVD) player, an audio player, an air conditioner, a cleaner, an oven, a microwave oven, a washing machine, an air cleaner, a set-top box, a home automation control panel, a security control panel, a media box (for example, Samsung HomeSync™, Apple TV™, or Google TV™), game consoles (for example, Xbox™, PlayStation™), an electronic dictionary, an electronic key, a camcorder, and an electronic frame.

According to an alternative embodiment, the electronic device may include at least one of a medical device (such as portable medical measuring devices (including a glucometer, a heart rate monitor, a blood pressure monitor, and a body temperature thermometer), a Magnetic Resonance Angiography (MRA) device, a Magnetic Resonance Imaging (MRI) device, a Computed Tomography (CT) device, a camcorder, and a microwave scanner), a navigation device, a Global Navigation Satellite System (GNSS), an Event Data Recorder (EDR), a Flight Data Recorder (FDR), an automotive infotainment device, marine electronic equipment (such as marine navigation system and gyro compass), aviation electronics (avionics), security equipment, an automotive head unit, an industrial or household robot, a drone, an Automatic Teller Machine (ATM), a Point Of Sales (POS) terminal, and an Internet-of-Things (IoT) device (such as electric bulb, sensor, sprinkler system, fire alarm system, temperature controller, street lamp, toaster, fitness equipment, hot water tank, heater, and boiler). According to an embodiment of the present disclosure, the electronic device may include at least one of furniture, a part of a building/structure, a part of a vehicle, an electronic board, an electronic signature receiving device, a projector, and a sensor (such as water, electricity, gas, and electric wave meters). According to various embodiments of the present disclosure, the electronic device may be flexible or a combination of at least two of the aforementioned devices. According to an embodiment of the present disclosure, the electronic device is not limited to the aforementioned devices. In the present disclosure, the term “user” may denote a person who uses the electronic device or a device (e.g., artificial intelligent electronic device) which uses the electronic device.

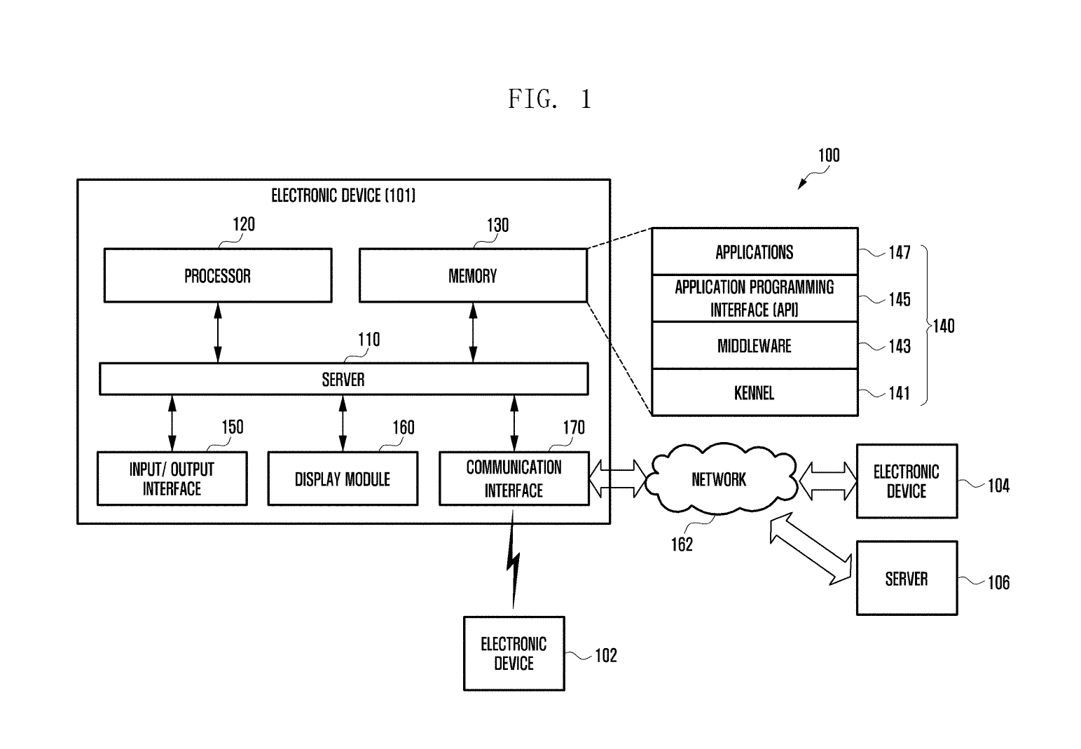

A description is made of the electronic device 101 in a network environment 100 with reference to FIG. 1. The electronic device 101 may include a bus 110, a processor 120, a memory 130, an input/output interface 150, a display 160, and a communication interface 170. In an embodiment, the electronic device 101 may be configured without at least one of the aforementioned components or with another component.

The bus 110 may include a circuit for interconnecting components 110 to 170 such that the components communicate signal (e.g., control message and data). The processor 120 may include at least one of a central processing device, an application processor, and a communication processor (CP). The processor 120 may execute operation related to the control of and/or communication among the other components constituting the electronic device 101 and perform data processing.

The memory 130 may include a volatile and/or non-volatile memory. The memory 130 may store a command or data associated with at least one of the components of the electronic device 101. According to an embodiment, the memory 130 may store software and/or programs 140. The programs 140 may include a kernel 141, a middleware 143, an application programming interface (API) 145, and/or an application program (or “application”) 147. At least part of the kernel 141, middleware, and API 145 may be referred to as operating system.

The kernel 141 may control or manage system resources (e.g., bus 110, processor 120, and memory 130) for use in executing operations or functions implemented in other programming modules (e.g., middleware 143, API 145, and application program 147). Further, the kernel 141 can provide an interface through which the middleware 143, the API 145, and/or the application 147 can access an individual element of the electronic apparatus 101 and then control and/or manage system resources.

The middleware 143 may relay the data communicated between the API 145 or the application program 147 and the kernel 141. The middleware 143 may process at least one task request received from the application program 147 according to priority. For example, the middleware 143 may assign a priority to at least one of the application programs 147 for use of the system resources (e.g., the bus 110, the processor 120, and the memory 130) of the electronic device 101 and process the at least one task request according to the assigned priority.

The API 145 may include an interface for controlling the functions provided by the kernel 141 and the middle 143 and includes at least one interface or function (e.g., command) for file control, window control, and video control, and text control, by way of example. The input/output interface 150 may relay a command or data input by a user or via an external electronic device to other component(s) of the electronic device 101 and output a command or data received from other component(s) of the electronic device 101 to the user or the external electronic device.

Examples of the display 160 may include a liquid crystal display (LCD), a light emitting diodes display (LED), a organic LED (OLED) display, a microelectromechanical systems (MEMS) display, and an electronic paper display. The display 160 may display various contents (e.g., text, image, video, icon, and symbol) to the user by way of example. The display 160 may include a touchscreen that is capable of receiving a touch, gesture, proximity, or hovering input made with an electronic pen or part of the user's body by way of example. The communication interface 170 may set up a communication channel between the electronic device 101 and an external device (e.g., first external electronic device 102, second external electronic device 104, and server 106). For example, the communication interface 170 may connect to the network 162 through a wireless or wireline communication channel to communicate with the external electronic device (e.g., second external electronic device 104 and server 106).

Examples of the wireless communication may include cellular communications using at least one of LTE, LTE Advanced (LTE-A), code division multiple access (CDMA), wideband CDMA (WCDMA), universal mobile telecommunications system (UMTS), Wireless Broadband (WiBro), and global system for mobile communications (GSM). According to an embodiment, examples of the wireless communication may include communications using at least one of wireless fidelity (Wi-Fi), Bluetooth, Bluetooth low energy (BLE), Zigbee, near field communication (NFC), magnetic secure transmission, radio frequency (RF), and body area network (BAN).

According to an embodiment, examples of the wireless communication may include GNSS communication. Examples of the GNSS may include a global positioning system (GPS), a global navigation satellite system (Glonass), a Beidou navigation satellite system (hereinafter, referred to as “Beidou”), and Galileo (the European global satellite-based navigation system). In the following description, the terms “GPS” and “GNSS” are interchangeably used. Examples of the wireline communication may include communications using at least one of universal serial bus (USB), high definition multimedia interface (HDMI), recommended standard 233 (RS-232), power line communication, and plain old telephone service (POTS). The network 162 may be a telecommunication network including a computer network (e.g., LAN and WAN), Internet, and telephony network, by way of example.

Each of the first and second external electronic device 102 and 104 may be identical to or different from the electronic device 101 in type. According to various embodiments, all or part of the operations being executed at the electronic device 101 may be executed at one or more other electronic devices (e.g., electronic devices 102 and 104 and server 106). According to an embodiment, if it is necessary for the electronic device 101 to execute a function or service automatically or in response to a request, the electronic device 101 may request to another device (e.g., electronic devices 102 and 104 and server 106) for executing at least part of related functions on its behalf or additionally.

The other electronic device (e.g., electronic devices 102 and 104 and server 106) may execute the requested function or additional function and notify the electronic device 101 of the execution result. The electronic device 101 may provide the requested function or service with execution result in itself or after performing additional processing thereon. In order to accomplish this, it may be possible to use a cloud computing, a distributed computing, or a client-server computing technology.

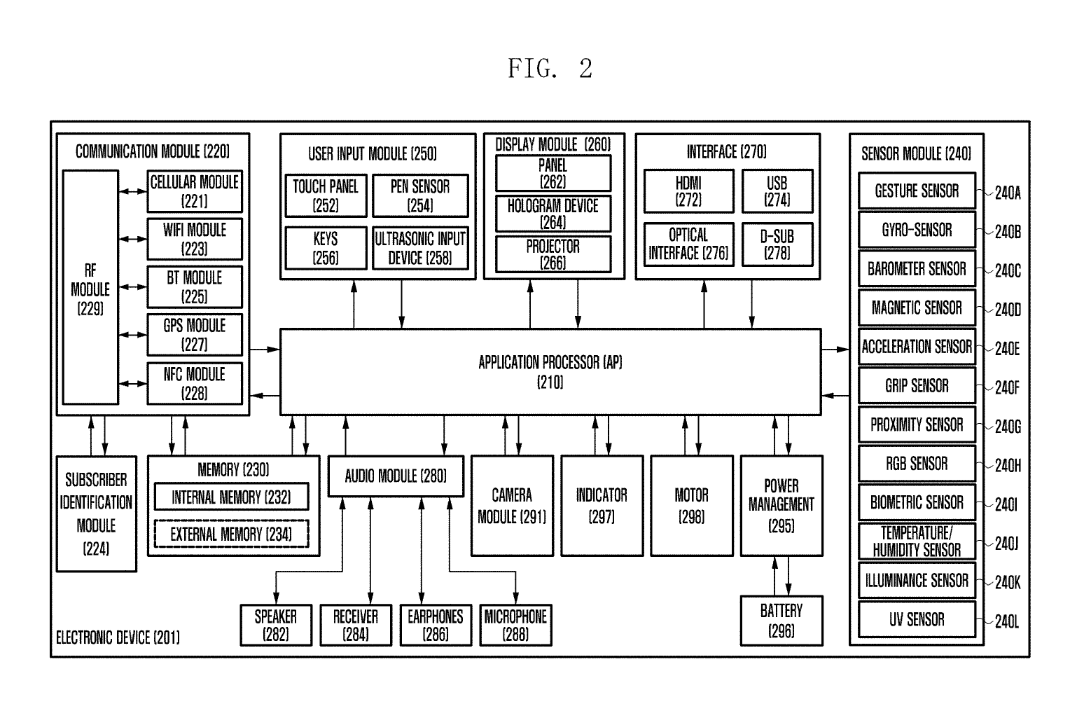

FIG. 2 is a block diagram illustrating an electronic device 201 according to various embodiments. The electronic device 201 may include all or part of the electronic device 101 depicted in FIG. 1. The electronic device 201 may include at least one processor (e.g., AP 210), a communication module 220, a subscriber identity module (SIM) 224, a memory 230, a sensor module 240, an input device 250, a display 260, an interface 270, an audio module 280, a camera module 291, a power management module 295, a battery 296, an indicator 297, and a motor 298.

The processor 210 may execute the operation system or an application program to control a plurality of hardware or software components connected to the processor 210 and perform various data processing and operations. The processor 210 may be implemented in the form of system on chip (SoC) by way of example.

According to an embodiment, the processor 210 may also include a graphic processing unit (GPU) and/or an image signal processor. The processor 210 may include at least part (e.g., cellular module 221) of the components depicted in FIG. 2). The processor 210 may load the command or data received from at lease one of other components (e.g., non-volatile memory) onto the volatile memory and store processed result data in the non-volatile memory.

The communication module 220 may have a configuration identical with or similar to that of the communication interface 170 by way of example. For example, the communication module 220 may include a cellular module 221, a Wi-Fi module 223, a Bluetooth module 225, a GNSS module 227, an NFC module 228, and an RF module 229. The cellular module 221 may provide a voice call service, a video call service, a text messaging service, and an Internet access service via a communication network, by way of example.

According to an embodiment, the cellular module 221 may identity and authenticate the electronic device 201 and perform identification and authentication on the electronic device 201 in the communication network by means of the subscriber identity module (SIM) 224. According to an embodiment, the cellular module 221 may perform part of the functions of the processor 210. According to an embodiment, the cellular 221 may include a communication processor (CP).

According to an embodiment, part of the cellular module 221, the Wi-Fi module 223, the Bluetooth module 225, the GNSS module 227, and the NFC module 228 (e.g., two or more) may be included in an integrated chip (IC) or an IC package. The RF module 229 may transmit/receive a communication signal (e.g., RF signal). The RF module 229 may include a transceiver, a power amplification module (PAM), a frequency filter, a low noise amplifier (LNA), and an antenna by way of example. According to an alternative embodiment, at least one of the cellular module 221, the Wi-Fi module 223, the Bluetooth module 225, the GNSS module 227, and the NFC module 228 may transmit/receive an RF signal via a separate RF module. The SIM 224 may include a card containing a subscriber identity module or an embedded SIM and contain unique identity information (e.g., integrated circuit card identifier (ICCID)) or subscriber information (e.g., international mobile subscriber identity (IMSI)).

The memory 230 (e.g., memory 130) may include an internal memory 232 and an external memory 234 by way of example. The internal memory 232 may include at least one of a volatile memory (e.g., DRAM, SRAM, and SDRAM), a non-volatile memory (e.g., one time programmable ROM (OTPROM)), PROM, EPROM, EEPROM, mask ROM, flash ROM, and flash memory, a hard drive, and a solid state drive (SSD) by way of example. The external memory 234 may include flash drive such as compact flash (CF), secure digital (SD), Micro-SD, Mini-SD. extreme digital (xD), multimedia card (MMC), and memory stick. The external electronic device 234 may be functionally or physically connected with the electronic device 201 via various interfaces.

The sensor module 240 may measure physical quantities or detects an operation state of the electronic device 201 and convert the measured or detected information to an electrical signal. The sensor module 240 may include at least one of a gesture sensor 240A, a gyro sensor 240B, a barometric pressure sensor 240C, a magnetic sensor 240D, an acceleration sensor 240E, a grip sensor 240F, a proximity sensor 240G, a color sensor 240H (e.g., a red, green, blue (RGB) sensor), a biometric sensor 240I, a temperature/humidity sensor 240J, an illumination sensor 240K, and an ultraviolet (UV) sensor 240M.

Additionally or alternatively, the sensor module 240 may include an e-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 240 may further include a control circuit for controlling at least one sensor therein. According to an embodiment, the electronic device 201 may further include another processor configured to control the sensor module 240 as part of or separated from the processor 210, and the another processor may control the sensor module 240 while the processor 210 is in a sleep state.

The input device 250 may include a touch panel 252, a (digital) pen sensor 254, a key 256, or an ultrasonic input device 258 by way of example. The touch panel 252 may use at least one of capacitive, resistive, infrared, or ultrasonic methods by way of example. The touch panel 252 may further include a control circuit.

The touch panel 252 may further include a tactile layer to provide tactile response to a user. The (digital) pen sensor 254 may include a sheet for recognition as part of a touch panel or a separate sheet for recognition. The key 256 may include a physical button, an optical key, or a keypad, by way of example. The ultrasonic input device 258 may detect ultrasonic waves generated by an input tool through a microphone (e.g., the microphone 288) and ascertain data corresponding to the detected ultrasonic waves.

The display 260 (e.g., the display 160) may include a panel 262, a hologram device 264, a projector 266, and a control circuit for controlling the aforementioned components. The panel 262 may be implemented to be flexible, transparent, or wearable. The panel 262 may include a touch panel 252 and at least one module.

According to an embodiment, the panel 262 may include a pressure sensor (or force sensor) that measures the intensity of touch pressure by a user. The pressure sensor may be implemented integrally with the touch panel 252, or may be implemented as at least one sensor separately from the touch panel 252. The hologram device 264 may display a stereoscopic image in the air using a light interference phenomenon. The projector 266 may display an image by projecting light on a screen. The screen may be placed inside or outside the electronic device 201 by way of example.

The interface 270 may include an HDMI 272, a USB 274, an optical interface 276, or a D-subminiature (D-sub) 278 by way of example. The interface 270 may be included in the communication interface 170 shown in FIG. 1 by way of example. Additionally or alternatively, the interface 270 may include a mobile high-definition link (MHL) interface, an SD card/MMC interface, or an infrared data association (IrDA) standard interface.

The audio module 280 may convert sounds into electrical signals and convert electrical signals into sounds. At least some components of the audio module 280 may be included in the input/output interface 145 shown in FIG. 1 by way of example. The audio module 280 may process sound information inputted/outputted through a speaker 282, a receiver 284, an earphone 286, or a microphone 288.

The camera module 291, as a device for capturing a still image and a video image, may include at least one image sensor (e.g., a front sensor or a rear sensor), a lens, an image signal processor (ISP), or a flash (e.g., an LED or a xenon lamp). The power management module 295 may manage the power of the electronic device 201. The power management module 295 may include a power management IC (PMIC), a charger IC, or a battery or fuel gauge. The PMIC may support a wireline and/or wireless charging methods. Examples of the wireless charging method may include a magnetic resonance method, a magnetic induction method, and an electromagnetic method, and the PMIC may further include supplementary circuit such as a coil loop, a resonant circuit, and a rectifier. The battery gauge may measure a remaining capacity of the battery 296, charging voltage and current, and temperature of the battery by way of example. The battery 296 may include a rechargeable battery and/or a solar battery by way of example.

The indicator 297 may display a specific state of the electronic device 201 or part thereof (e.g., the processor 210), such as a booting state, a message state, or a charging state. The motor 298 may convert electrical signals into mechanical vibration and may generate vibration or haptic effect. The electronic device 201,

may include a mobile TV-support device (e.g., a GPU) for processing media data generated in compliance with the standards such as digital multimedia broadcasting (DMB), digital video broadcasting (DVB), and mediaFLO™. Each of the above-mentioned components may be configured with at least one component and the name of a corresponding component may vary according to the type of an electronic device. According to various embodiments, the electronic device (e.g., electronic device 201) may be configured without part of the aforementioned components or with additional components; part of the components may be combined into one entity capable of executing the same functions of the components before being combined.

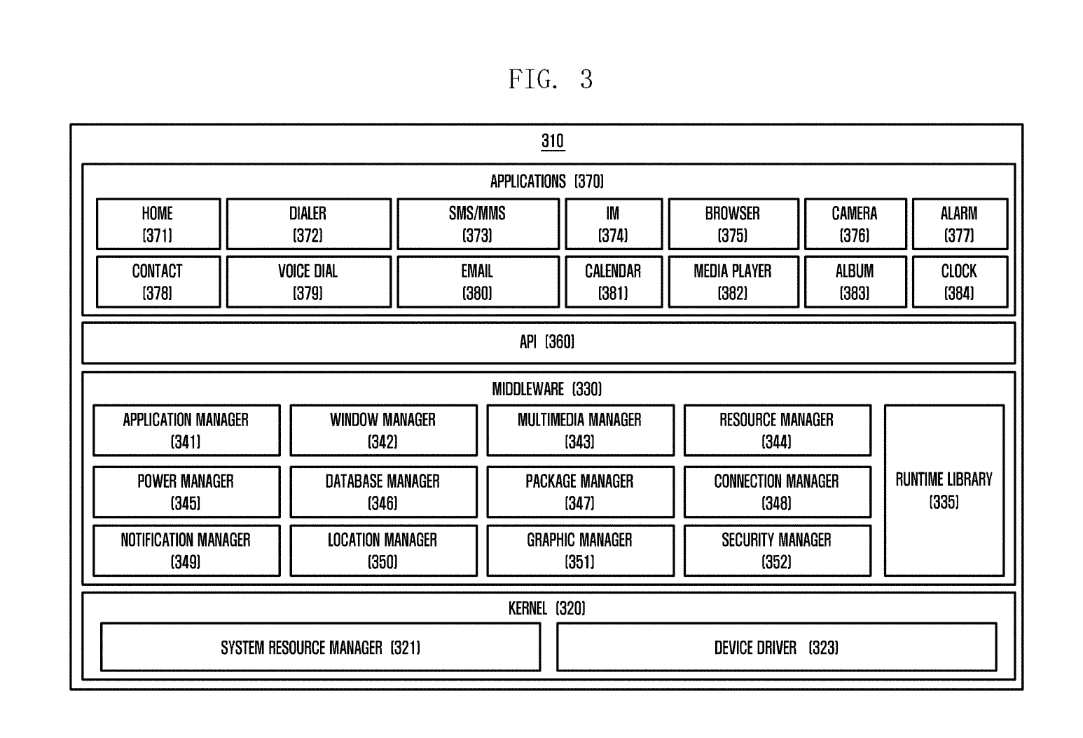

FIG. 3 is a block diagram illustrating a program module according various embodiments. According to an embodiment, the program module 310 (e.g., program 140) may include an operating system for controlling the resources of the electronic device (e.g. electronic device 101) and various applications (e.g., application program 147) running on the operating system. The operating system may include Android™, iOS™, Windows™, Symbian™, Tizen™, and Bada™ for example. In reference to FIG. 3, the program module 310 may include a kennel 320 (e.g., kernel 141), a middleware 330 (e.g., middleware 143), an API 360 (e.g., API 145), and an application 370 (e.g., application 147). At least part of the program module 310 may be pre-loaded on the electronic device or downloaded from an external electronic device (e.g., electronic devices 102 and 104).

The kernel 320 may include a system resource manager 321 a device driver 323 by way of example. The system resource manager 321 may control, assign, or withdraw the system resources.

According to an embodiment of the present disclosure, the system resource manager 321 may include a process manager, a memory manager, and a pile system manager. The device driver 323 may include a display driver, a camera driver, a Bluetooth driver, a common memory driver, a USB driver, a keypad driver, a Wi-Fi driver, an audio driver, and an inter-process communication (IPC) driver. The middleware 330 may provide a function for use by the applications in common and various functions for allowing the applications 370 to use the restricted system resources of the electronic device efficiently through the API 360.

According to various embodiment, the middleware 330 may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, a security manager 352.

The runtime library 335 may include a library module for use by a compiler to add new functions with a programming language while the applications 370 are in running. The runtime library 335 may perform input/output management, memory management, and arithmetic function processing. The application manager 341 may manage the life cycles of the applications 370 by way of example.

The window manager 342 may manage the GUI resources in use for screens. The multimedia manager 343 may check the formats of media files to encode or decode the media files using the codecs proper to the corresponding formats. The resource manager 344 may manage source codes of the applications 370 and memory space. The power manager 345 may mange battery capacity and power by way of example and provide power information necessary for the operation of the electronic device. According to an embodiment, the power manager 345 may interoperate with a basic input/output system (BIOS). The database manager 346 may generate, search, and modify a data based for use by the applications 370 by way of example. The package manager 347 may manage installation and update of application distributed in the form of a package file.

The connectivity manager 348 may manage a wireless connection by way of example. The notification manager 349 may provide the user with events such as incoming message alarm, appointment alarm, and proximity alarm by way of example. The location manager 350 may manage location information of the electronic device. The graphic manager 351 may manage graphical effects and user interfaces to be provided to user by way of example. The security manager 352 may responsible for system security and user authentication by way of example.

According to an embodiment, the middleware 330 may include a telephony manager for managing voice and video call functions of the electronic device and a middleware module capable of combining the functions of the aforementioned components. According to an embodiment, the middleware 330 may provide operation system type-specific modules. The middleware 330 may delete part of the existing components or add new components dynamically. The API 360 may provide operating system type-specific API program functions sets by way of example. For example, it may be possible to a set of APIs per platform for the case of the android or iOS and two or more sets of APIs per platform for the case of the Tizen.

The applications 370 may include a home 371, a dialer 372, an SMS/MMS 373, an instant message (IM) 374, a browser 375, a camera 376, an alarm 377, a contact 378, a voice dial 379, an email 380, a calendar 381, a media player 382, an album 383, a watch 384, a health care (e.g., workout amount and blood sugar), environmental information provision application (e.g., atmospheric pressure, humidity, and temperature).

According to an embodiment, the application 370 may include an information exchange application for supporting information exchange between the electronic device and an external electronic device. The information exchange application may include a notification relay application for relaying specific information to the external electronic device and a device management application for managing the external electronic device by way of example. The notification relay application may relay notification information generated by another application of the electronic device to the external electronic device or provide the user with the notification information received from the external electronic device.

The device management application may manage the functions of the external electronic device (e.g., turn-on/off of the external electronic device in itself (or a component thereof) and brightness (or resolution) adjustment of the display) communicating with the electronic device and install, uninstall, or update the applications operating on the external electronic device by way of example. According to an embodiment, the application 370 may include an application (e.g., healthcare application of a mobile medical device) designated according to the property of the external electronic device. According to an embodiment, the applications 370 may include an application received from the external electronic device. At least part of the application module 310 may be implemented (e.g., executed) in the form of software, firmware, hardware, or a combination of at least two thereof and include a module, a program, a routine, a command set, or a process for performing at least one function.

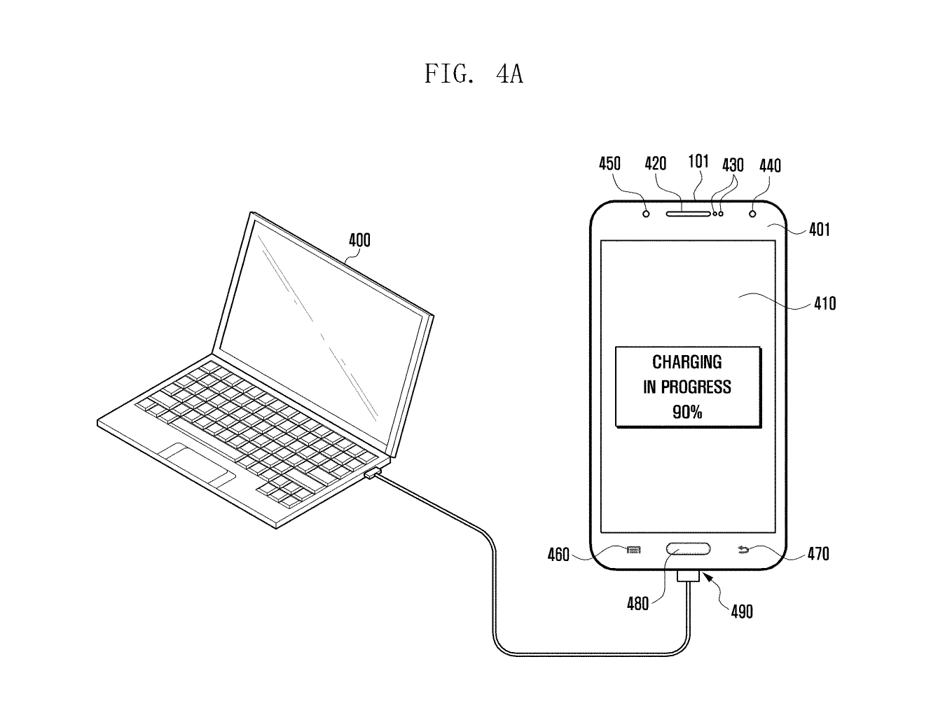

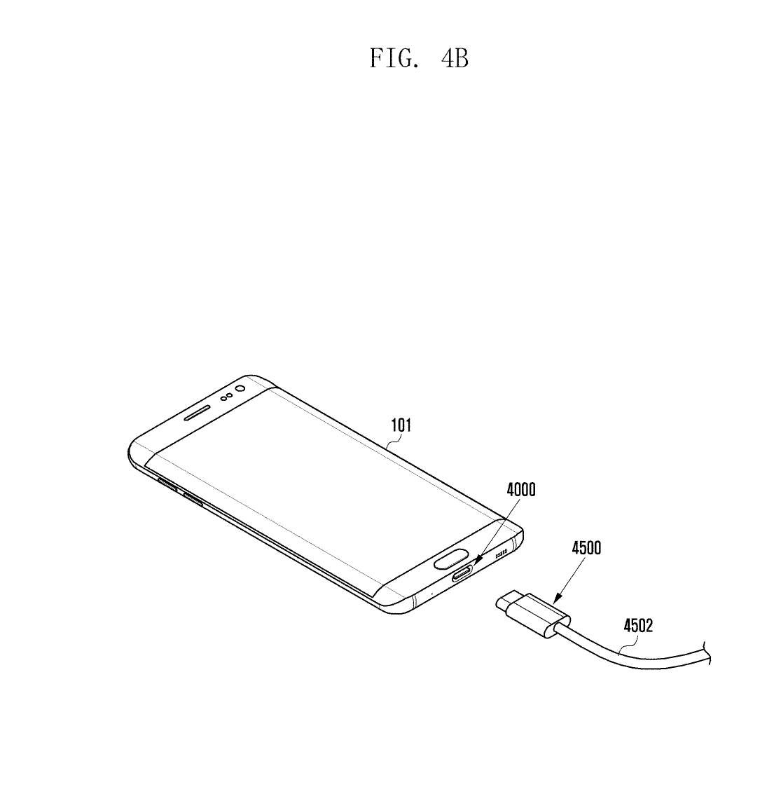

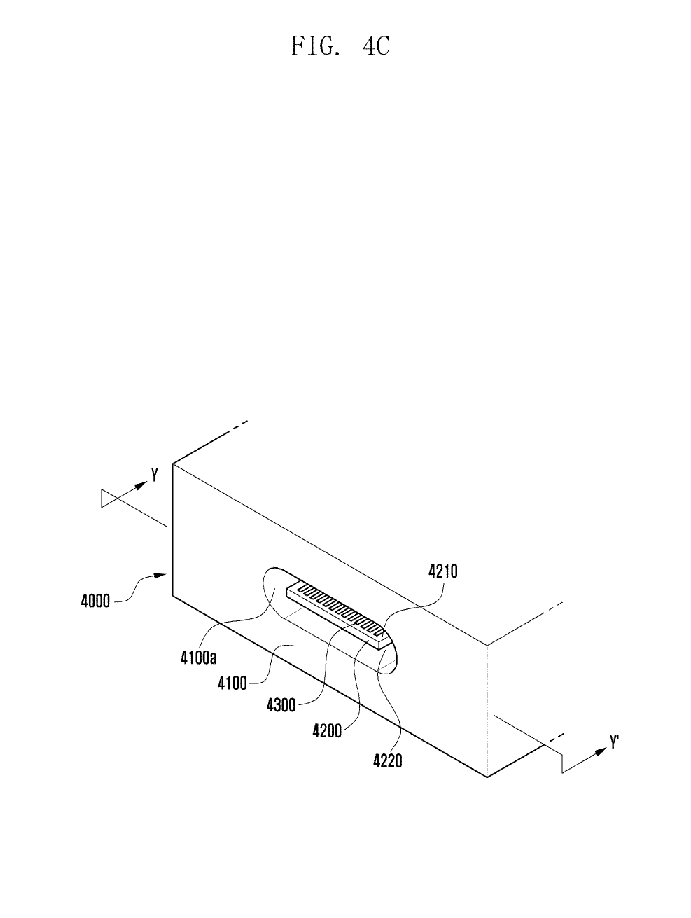

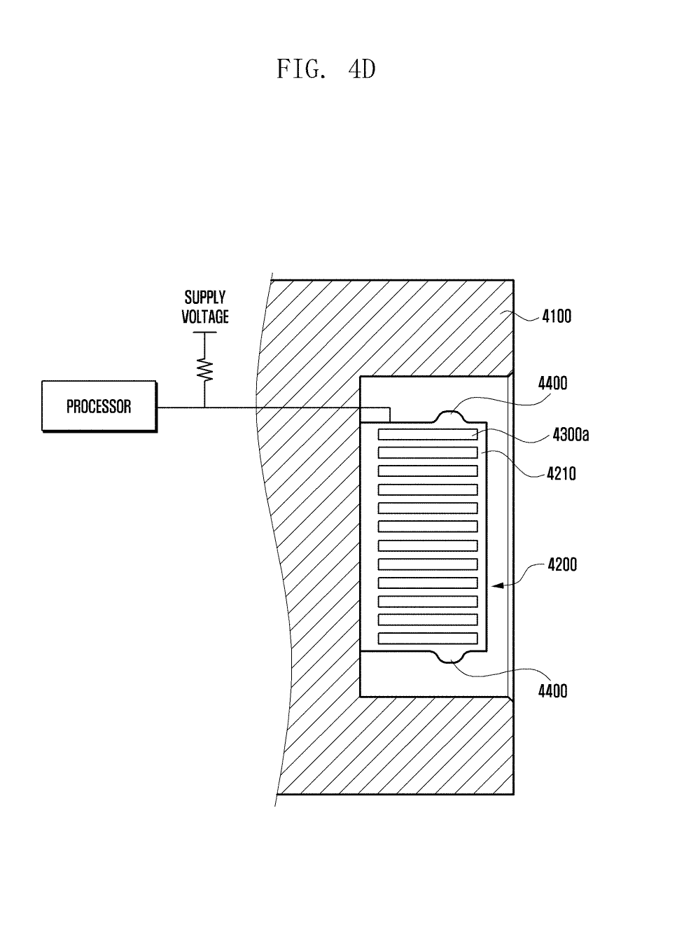

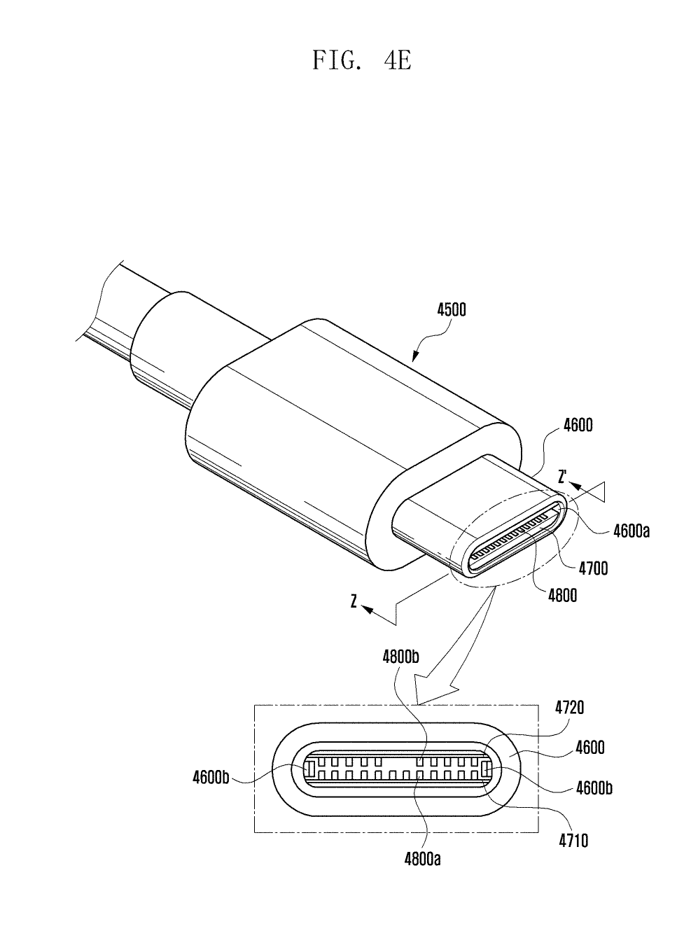

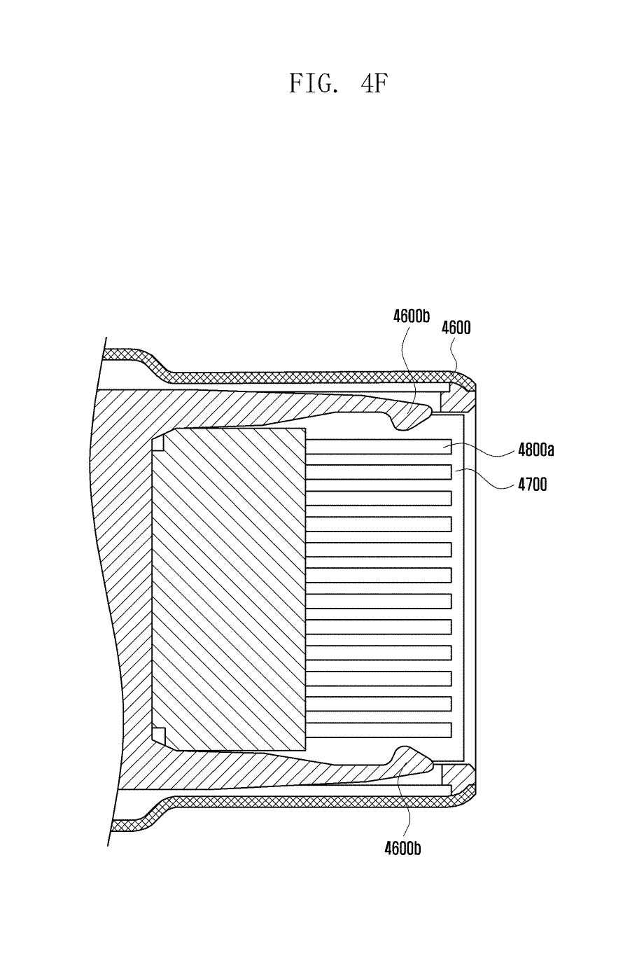

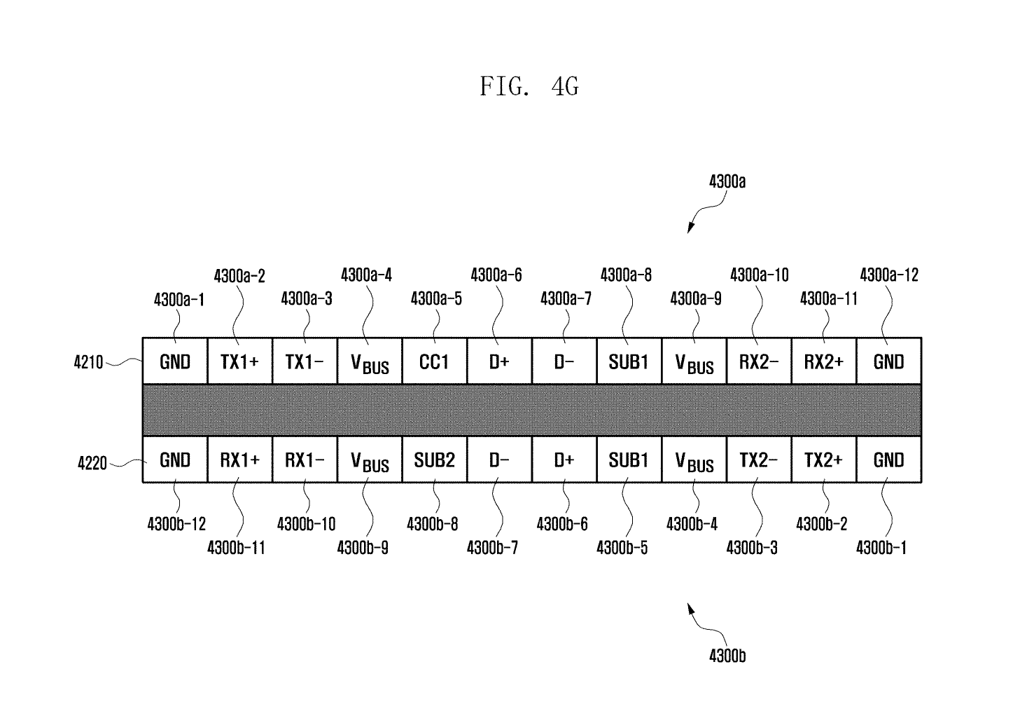

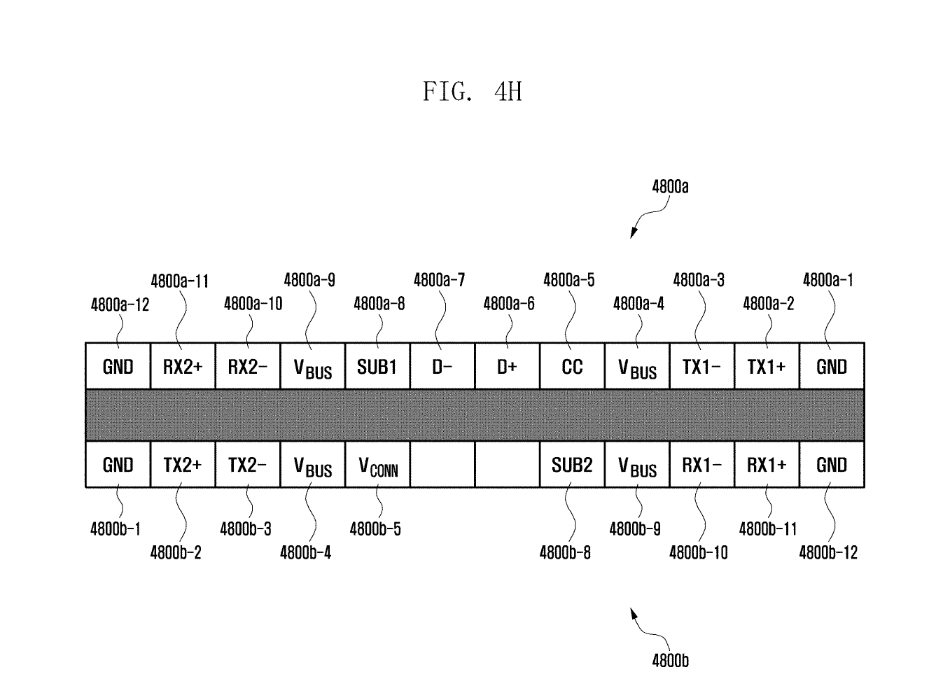

FIG. 4A is a diagram for explaining a situation where an electronic device is charged by another electronic device according to various embodiments.

In reference to FIG. 4A, the electronic device 101 may be implemented as varies type of devices for various purposes. Examples of the electronic device 101 may include, but are not limited to, a portable phone, a smartphone, a notebook computer, a tablet computer, and a wearable device.

In reference to FIG. 4A, the electronic device 101 may be provided with a display 410 on its front side. The display 410 may be implemented as a touchscreen. A speaker 420 for outputting voice sound may be mounted on the front side above the display 410. A hard key 480 (e.g., home key) and soft keys 460 and 470 may be mounted on the front side below the display 410.

According to an embodiment, the electronic device 101 may be provided with components around the speaker 420 for implementing various functions.

According to various embodiments, the components may include at least one sensor module 430. For example, the components may include at least one of an illumination sensor (optical sensor), a proximity sensor, an infrared sensor, and an ultrasonic sensor. According to various embodiments, the components may include a camera 440. According to various embodiments, the components may also include an LED indicator 450 for providing a user with information on the status of the electronic device 101.

According to various embodiments, the electronic device 101 and an external electronic device 400 are connected to each other via a wired communication interface. For example, the electronic device 101 and the external electronic device 400 may be connected to each other via a video communication interface (e.g., HDMI interface, DisplayPort interface, HML interface, and USM Audio Video device interface). The external device 400 may be a source device for generating content data (e.g., video data), and the electronic device 101 may be a sink device for receiving the content and outputting or playing the received content. And also, vice versa.

According to various embodiments, the electronic device 101 and the external electronic device 400 may be connected to each other via a USB communication interface. The external electronic device 400 may act as a USB host, and the electronic device 101 may operate as a USB client. And also, vice versa.

The electronic device 101 and the external electronic device 400 may be connected with each other via a connector 490. The connector 490 may transfer analog or digital data to the outside of the device. According to various embodiments, the connector 490 may be a USB TYPE C connector. The electronic device 101 and the external electronic device 400 may mutually exchange data and power via the USB TYPE C connector.

According to various embodiments, in the case where the electronic device 101 and the external electronic device 400 are connected via the USB TYPE C connector, they may operate in an alternate mode. For example, a video signal of the video communication interface (e.g., VESA DisplayPort interface) may be transmitted or received via the USB connector.

In this disclosure, the wired communication interface and connector of the electronic device 101 and the external electronic device 400 are not limited in type.

In the case of being electrically connected to the external electronic device 400, the electronic device 101 may be charged from the external electronic device 400. For example, the electronic device 101 may receive power supply from the external electronic device 400 via a power terminal of the connector (e.g., V BUS of USB connector). The electronic device 101 may operate itself and charge its battery (not shown) with the power supplied from the external electronic device 400.

According to various embodiments of the present invention, the electronic device 101 and the external electronic device 400 may exchange their information via an ID terminal (not shown) of the connector 490 to identify each other.

According to various embodiments, the connector 490 may include an ID terminal supporting a ‘digital ID’ scheme (e.g., CC terminal of USB Type C connector). According to various embodiments, the connector 490 may include an ID terminal supporting a ‘resistance ID’ scheme (for example ID terminal of micro USB connector).

The power supplied from the external electronic device 400 may be used in part for operating the electronic device 101 and supplied in part to still another electronic device (not shown) via a separate power terminal (not shown). For example, the external electronic device may operate itself or charge a battery electrically connected thereto with the power supplied from the external electronic device 400 via the electronic device 101.

According to various embodiments, the electronic device 101 and the external electronic device 400 may be connected to each other via various communication interfaces. For example, the electronic device 101 may include a high definition multimedia interface (HDMI), an optical interface, a D-SUB, and a Lightning interface of which at least one is used for connection with the external device 400. Although the specific connection interfaces have been enumerated by way of example, the wired communication interfaces and connectors are not limited in type in the present disclosure.

FIG. 4B is a perspective view illustrating an electronic device with a USB Type C interface according to various embodiment of the present invention. FIG. 4C is an enlarged view of a connector according to various embodiments of the present invention. FIG. 4D is a cross-section view taken along Y-Y′ in FIG. 4C.

In reference to FIGS. 4B to 4D, the connector 4000 of the electronic device may receive an external connector. The electronic device 101 having the connector 4000 may be a radio communication terminal and connect to an external device via a cable 4502 having the external connector 4500. The external connector 4500 is designed to be inserted into the connector 4000 of the electronic device.

According to various embodiments, the connector 4500 may include a housing 4100 with a terminal mounting unit 4200 which has a plurality of grooves (not shown) in which a plurality of connection terminals 4300 are situated and which also has a pair of first coupling units 4400 formed at opposite sides thereof.

According to various embodiments, the housing 4100 may be provided with an opening 4100a for receiving the external connector 4500. The terminal mounting unit 4200 may be partly exposed through the opening 4100a of the housing 4100. Accordingly, the terminal mounting unit of the external connector 4500 may be inserted into the housing 4100 through the opening 4100a to contact with the terminal mounting unit 4100 of the connector 4000.

The terminal mounting unit 4200 is provided a plurality of grooves in which a plurality of connection terminals 4300 are situated. For example, the terminal mounting unit 4200 may include a first side 4210 and a second side 4220 that face opposite directions and have a plurality of grooves formed respectively thereon. For example, the number of grooves may be 12. However, the number of grooves is not limited thereto, and it may be variously determined according to the number of connection terminals 4300 to be situated therein. Each of the grooves may be filled with a terminal or remain empty.

The connection terminals 4300 may be elastic and slightly protruded outside the grooves. This aims to make it possible for the terminal mounting unit of the external connector 4500 to be tightly situated inside the housing 4100. The first coupling units 4400 are a device for tightly coupling the connector 4000 with the external connector 4500. For example, the first coupling units 4400 are arranged to be protruded outward from opposite sides of the terminal mounting unit 4200 so as to contact with part of the external connector 4500. However, the configuration is not limited to the above-described one.

FIG. 4E is a perspective view illustrating an external connector according to various embodiments of the present invention. FIG. 4F is a cross-section view taken along Z-Z′ in FIG. 4E.

In reference to FIGS. 4B, 4E, and 4F, the external connector 4500 according to various embodiments of the present invention may include a housing 4600 and a terminal mounting unit 4700 placed inside the housing 4600 and having a plurality of grooves (not shown) in which a plurality of external connection terminals 4800 are situated.

The housing 4600 may be provided with an opening 4600a for receiving the external connector 4500. The housing 4600 may have second coupling units 4600b protruded from its opposite inner walls for preventing the first coupling units 4400 of the connector 4000 from slipping out. For example, the second coupling units 4600b may be implemented in the form of, but are not limited to, a latch to be near to the first coupling unit 4400.

The terminal mounting unit 4700 is provided with a plurality of grooves in which a plurality of external connection terminals 4800 are situated and of which number is identical with that of the connector 4000. Each of the grooves may be filled with a terminal or remain empty. According to various embodiments of the present invention, the connector 4000 and the external connector 4500 may be USB 3.1 connectors, and the external device being connected via the connectors may act as a role of a USB host or a USB device. Accordingly, in order to secure the extendibility of the interface, all of the grooves may be filled with external connection terminals 4800.

The external connection terminals 4800 which are arranged on the terminal mounting unit 4700 may contact the corresponding connection terminals 4300 of the connector 4000 when the housing 4600 of the external connector 4500 is inserted into the housing 4100 of the connector 4000.

Table 1 summarizes functions of the terminals described in the embodiments of FIGS. 4G and 4H. For example, the connection terminals 4300 may include first connection terminals 4300a arranged on a first surface 4210 and second connection terminals 4300b arranged on a second surface 4220. As described above, the first and second connection terminals 4300a and 4300b may be symmetrically arranged around the center of the terminal mounting unit 4200 in such a way of being situated in the corresponding grooves.

According to various embodiments, in the case where the connection terminals 4300 include the first terminals 4300a arranged on the first surface and the second terminals 4300b arranged on the second surface of the terminal mounting unit 4200, the external connection terminals 4800 may include first external connection terminals 4800a arranged on a first terminal mounting unit 4710 and second external connection terminals 4800b arranged on a second terminal mounting unit 4720 facing the first terminal mounting unit 4710, the first and second external connection terminals 4800a and 4800b corresponding to the first and second connection terminals 4300a and 4300b.

According to various embodiments, the numbers of the first and second connection terminals 4300a and 4300b and the numbers of the first and second external connection terminals 4800a and 4800b may be 12 each as shown in Table 1, and all or part of the connection terminals may be arranged on the terminal mounting units 4200 and 4700 of the connectors 4000 and 4500. In Table 1, the terminal number may indicate the location of a terminal of the connector. That is, the terminal number 1 may indicate the terminal located at the right most groove of the terminal mounting units 4200 and 4700 of the connectors 4000 and 4500, and the terminal number 12 may indicate the terminal located at the left most groove.

TABLE 1

| Termnal number | Signal Name | Note |
|---|---|---|
| 1 | GND | Ground |
| 2 | TX+ | Super speed TX positive |
| 3 | TX− | Super speed TX negative |
| 4 | VBUS | USB cable charging power |
| 5 | CC | Identity terminal |
| 6 | D+ | +line of the differential bi- |
| | | directional USB signal |
| 7 | D− | −line of the differential bi- |
| | | directional USB signal |
| 8 | SBU | Side Band Use: additional |
| | | purpose pin (ex: Audio signal, |
| | | display signal, etc.) |
| 9 | VBUS | USB cable charging power |
| 10 | RX− | Super speed RX negative |
| 11 | RX+ | Super speed TX positive |
| 12 | GND | Ground |

According to various embodiments, the connector 4000 and the external connector 4500 on the USB 3.1 protocol may support both the USB host and USB device as described above.

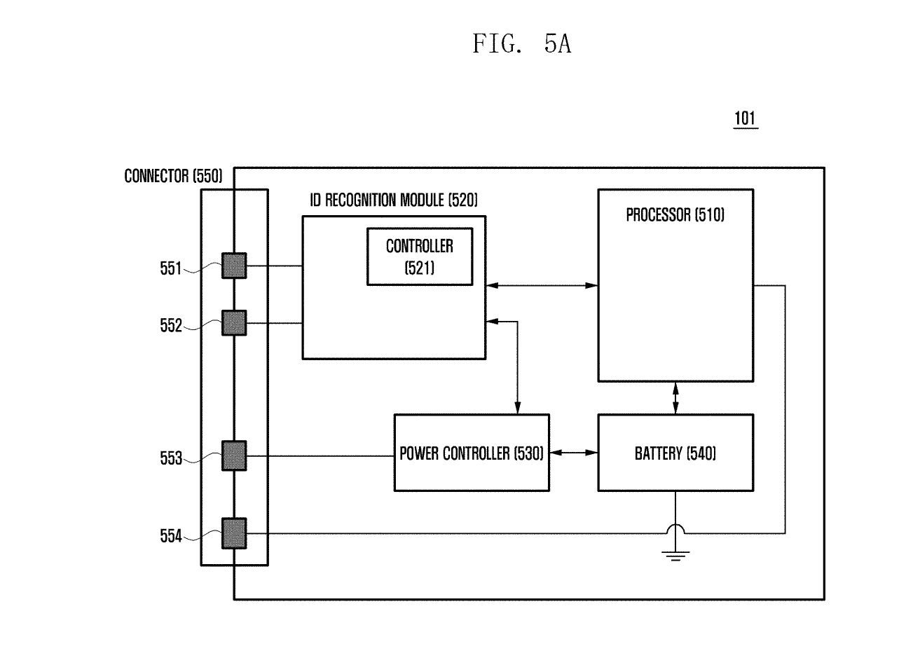

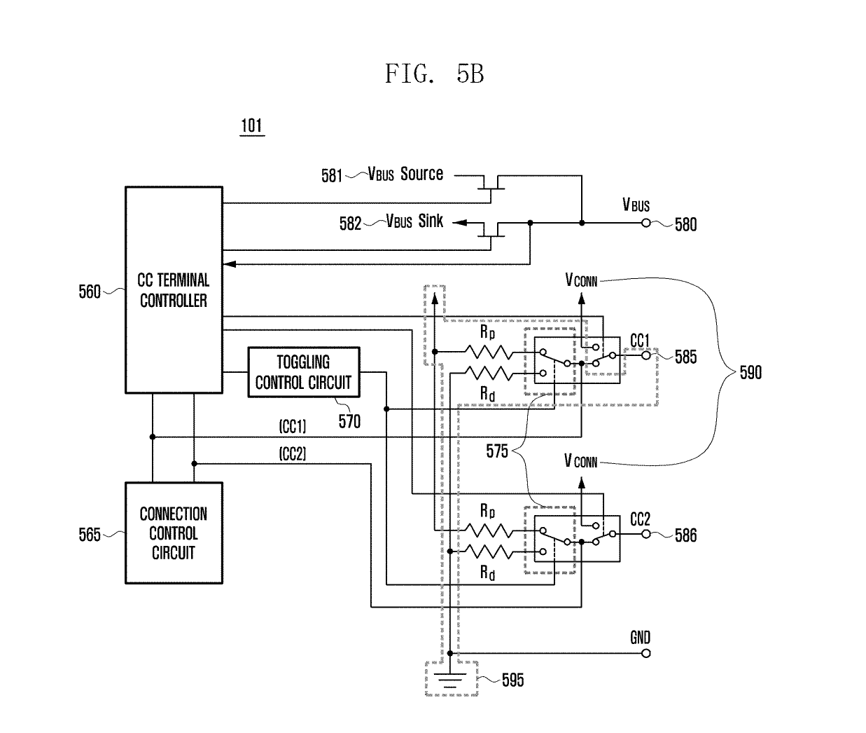

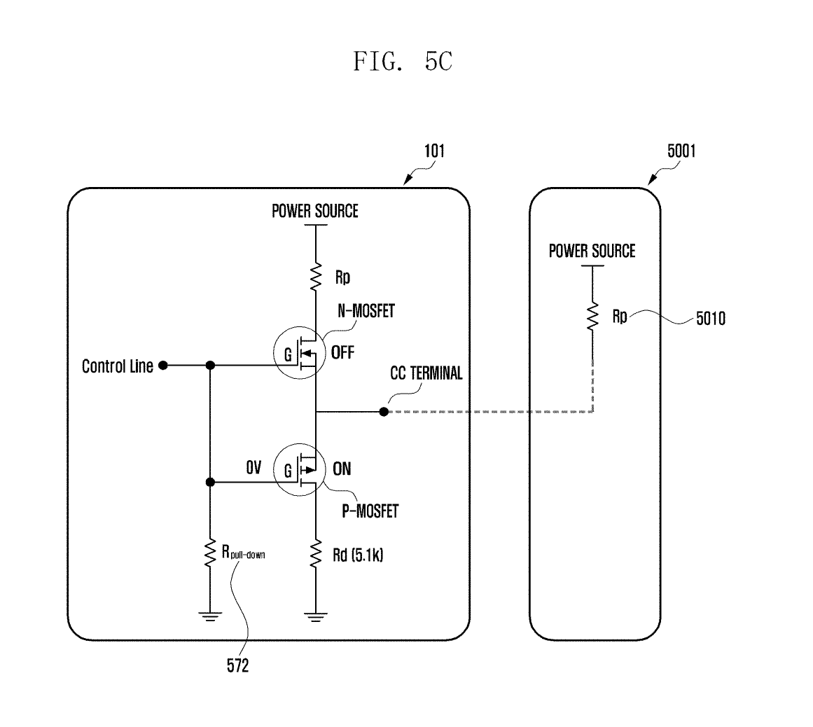

FIG. 5A is a schematic block diagram illustrating an electronic device according to various embodiments of the present invention.

In reference to FIG. 5, the electronic device 101 may include a processor 510, an ID recognition module 520, an ID recognition module controller 521, a power controller 530, a battery 540, and a connector 550. The electronic device 101 may also include a connection detection circuit (not shown) for detecting a connection of another electronic device (not shown).

The processor 510 may control operations of the electronic device 101 and/or signal flows among the components of the electronic device 101 and perform a data processing function. For example, the processor 510 may be a central processing unit (CPU), an application processor (AP), or a micro control unit (MPU). The processor 510 may be implemented as a single core processor or a multi-core processor. The processor 510 may include at least part of the configurations and functions of the processor 120 depicted in FIG. 1 and/or the processor 210 depicted in FIG. 2.

The ID recognition module 520 may be connected to a first ID terminal 551 and a second ID terminal 552, identify the external electronic device connected via the connector 550, and send information on the external electronic device to the processor 510. The ID recognition module 520 may be implemented as part of the processor 510 as well as in the form of a chip separated from the processor 510 as shown in the drawing.

In the case of the USP TYPE C connector, the ID terminals 551 and 552 may correspond to configuration channel (CC) terminals, and the ID recognition module 520 may corresponds to a configuration channel integrated circuit (CCIC). The USB TYPE C connector may have 2 CC terminals. For example, the CCIC (corresponding to ID recognition module 520) may determine the directivity of the cable connected to the connector 550 to use one of the CC terminals for the purpose of transmitting power through the cable (or to the external electronic device) and the other for the purpose of communication with the device connected through the cable to identify the connected device and manage the connection.

The power controller 530 may mange the power supplied to the electronic device. The power controller 530 may include a power management integrated circuit (PMIC) (not shown), a voltage adjuster (not shown), a power input/output unit (not shown), and a charger integrated circuit (IC) (not shown). The power controller may also include power control and voltage adjustment functions being implemented by combining various ICs, circuits, and software. If an external electronic device (not shown) is connected to the electronic device 101, the power controller 530 may control the electronic device to receive a power supply from the external electronic device via the power terminal 553 of the connector 550. The power controller 530 may include at least part of the configuration and functions of the power management module 295 of FIG. 2.

The battery 540 may supply power to respective components of the electronic device 101. The battery 540 may be a secondary rechargeable battery by way of example. The battery 540 may be an external battery electrically connected to the electronic device 101, an internal battery built in the electronic device 101, or a detachable battery that can be attached to or detached from the electronic device 101 by the user. The battery 540 may include at least part of the configuration or functions of the battery 296 of FIG. 2.

The connector 550 may include a device for functional connection to the electronic device 400. The connector 550 may include the ID terminals 551 and 552 for identifying a connected external device (not shown) and/or supply power to the external device via a cable, a power terminal 553 for supplying power or receiving signals, a data communication terminal 554 for data communication with the electronic device 400, and/or a ground terminal (not shown).

According to various embodiments, the connector 550 may comply with a USB connector standard. In this case, the power terminal may correspond to a VBUS terminal of the USB connector, and the data communication terminal 443 may correspond to D+ and D− terminals or Tx and Rx terminals.

The power terminal 553 may be used to receive power from another electronic device (not shown). The data terminal 554 may include D+ and D− of the USB connector and/or Tx+/− and Rx+/− of the USB connector by way of example. The terminals may be referred to as various terms depending on the connector. The external electronic device 500 may communicate information with the electronic device 400 via the data communication terminal 543.

According to various embodiments, in the case where the electronic device 101 is connected to an external electronic device (not shown) via a USB 2.0 cable, it may operate such that power is always induced via the power terminal 553. In the case where the electronic device 101 is connected to an external electronic device (e.g., USB 3.1 Power Delivery) via the USB TYPE C interface, it may perform an operation for determining the host for power supply with the external electronic device using the ID recognition module 520.

FIG. 5B is a schematic circuit diagram illustrating an electronic device controlling a USB TYPE C interface according to various embodiments of the present invention.

In reference to FIG. 5B, the control circuit of the electronic device 101 may include a CC terminal controller 560, a connection control circuit 565, a toggling control circuit 570, a switch 575, a VBUS terminal 580, a CC1 terminal 585, and a CC2 terminal 586.

The CC terminal controller 560, the VBUS unit 580, the CC1 terminal 585, and the CC2 terminal 586 may correspond to the ID recognition module controller 521, the power terminal 553, the first ID terminal 551, and the second ID terminal 552 respectively of FIG. 5A.

According to various embodiments, if the electronic device 101 operates as a host for power supply, it may receive power supply via the VBUS source 581 and supply the power to another electronic device via the VBUS terminal 580. In the case where the electronic device 101 receives power, it may receive power supply from another electronic device via the VBUS terminal 580 and transfer the power to the VBUS sink 582. The electronic device 101 may transfer or receive power to or from another electronic device over a USB TYPE C cable connecting the devices via the VCONN terminal 590.

At least part of the CC terminal controller 560, the connection control circuit 565, and the toggling control circuit 570 may be implemented as an integrated circuit (IC) or field-programmable gate array (FPGA) as a circuit for identifying the operation modes of the electronic device 101 and another electronic device (not shown).

The CC terminal controller 560 may be an application processor (AP), a central processing unit (CPU), or a micro controller unit (MCU) of the electronic device 101. The CCP controller 560 may receive information on the operation modes of the electronic device 101 and the external device 102 from the connection control circuit 860. This information may be received from the connection control circuit 860 in the form of an interrupt request (IRQ) by way of example.

The CC terminal controller 560 may perform subsequent operations in the operation mode of the electronic device 101 and the external device 102. For example, the CC terminal controller 560 may transmit operation mode-related supplementary data, authenticate the external device 102, or perform a communication procedure complying with a USP power delivery (PD) standard. At least part of such operations may be performed by the connection control circuit 860.

The toggling control circuit 570 may control the switch 575 to generate pull up resistance (Rp) or pull down resistance (Rd) to the CC1 terminal 585 and/or CC2 terminal 586.

The connection control circuit 565 supplies electric current to the CC1 terminal 585 and/or CC2 terminal 586 to detect the resistance of another electronic device (not shown) connected to the electronic device 101. In this case, the electronic device 101 and the another electronic device may take their roles as a host (e.g., downstream facing port (DFP)) and a slave (e.g., upstream facing port (UFP)) based on the voltage levels induced to the CC1 terminal 585 or the CC2 terminal 586 and operate distinctively according to their roles.

In detail, the USB interface supporting USB TYPE C in compliance with the USB standard makes it possible for the electronic device 101 and another electronic device to operate as one of a host device or a slave device.

According to various embodiments, if the electronic device 101 enters a dual role port (DRP) mode, the electronic device 101 with the USB TYPE C interface may operate as one or both of the host and slave devices.

According to various embodiments, if the electronic device 101 enters a DFP mode, the electronic device 101 with the USB TYPE C interface may operate as a host device to another electronic device connected via the USB interface.

If the electronic device 101 enters the DFP mode, the electronic device 200 may operate as a power source for supplying power to another electronic device (e.g., electronic devices 102 and 104 and server 106) connected thereto through a USB cable or as a hub for delivering data.

According to an embodiment, if the electronic device 101 enters a UFP mode, the electronic device 101 with the USB TYPE C interface may operate as a slave device to another electronic device connected via the USB.

If the electronic device 101 enters the UFP mode, it may operate as a sink for receiving power supply and data from another electronic device (e.g., electronic devices 102 and 104 and server 106) connected thereto through a USB cable.

As described above, in the case where the electronic device 101 and another electronic device connected thereto through the USB Type C interface need to determine their roles for power supply to the electronic device 101, if the processor of the electronic device 101 or a communication interface controller is not activated, the electronic device may fail to receive power supply. Thus, there is a need of a method for receiving power supply from the connected electronic device even when the processor 510 of the electronic device 101 or the communication interface controller is not activated.

For example, in the case where the electronic device 101 is in operation, the toggling control circuit 570 may control switches 575 to produce the pull up resistance and the pull down resistance alternately to the CC1 terminal 585 and/or CC2 terminal 586. The electronic device 101 may perform the above described operation during a predetermined period after the power-off of the electronic device 101.

According to various embodiments, if the system power becomes equal to less than a predetermined value, the electronic device 101 may stop the above described operations. For example, the predetermined value may be 3.0 V. In this state, the electronic device 101 may not operate normally.

The electronic device 101 may be configured to produce the pull down resistance to the CC1 terminal 585 and/or CC2 terminal 586 when the system power becomes equal to or less than the predetermined value. For example, if the system power becomes equal to or less than the predetermined value, the CC terminal controller 560 may control the switches 575 to produce the pull down resistance to the CC1 terminal 585 and/or CC2 terminal 586. According to various embodiments, the switches 575 may be configured to produce the pull down resistance when the system power dissipates because the electronic device 101 is turned off.

In the case where the electronic device 101 configured to produce the pull down resistance to the CC1 terminal 585 and/or CC2 terminal 586 upon fulfillment of a predetermined condition is electrically connected to another electronic device, the connected electronic device may supply power to the electronic device without any operation for determining their roles.

In detail, the connected electronic device may supply a predetermined amount of electric current to the CC1 terminal 585 and/or CC2 terminal 586 of the electronic device 101. For example, the connected electronic device may supply the electric current of about 330 μA. If it is determined that the electric current of 330 μA generates a voltage of 1.683 V with a resistance of 5.1 KΩ produced on the CC1 terminal 585 and/or CC2 terminal 586 of the electronic device 101, it may begin supplying power to the electronic device 101.

FIG. 5C is a circuit diagram illustrating a circuit for producing a pull-down resistance to a CC terminal when the electronic device 101 satisfies a predetermined condition according to an embodiment of the present invention.

According to various embodiments, the electronic device 101 may be implemented with a switch operation circuit with the characteristics of a semiconductor device for producing the pull-down resistance on the CC terminal.

FIG. 5C is a diagram for explain part 595 associated with the operation of the switches 575 of FIG. 5B. According to various embodiments, the switches 575 may be implemented with a metal oxide semiconductor field effect transistor (MOSFET). In this case, when the system power is normally induced, a P-MOSFET and an N-MOSFET are turned on the toggling control circuit 570 such that the electronic device 101 and the connected electronic device may take a role of host (e.g., DFP, power source) and slave (e.g., UFP, power sink), respectively, or vice versa.

According to various embodiments, if the P-MOSFET is turned on, a pull-down resistor (Rd) is activated in order for the electronic device 101 to take a role of power sink; if the N-MOSFET is turned on, a pull up resistor (Rp) is activated in order for the electronic device 101 to take a role of power source. In the case where the system power is abnormal as described in this disclosure, however, the P-MOSFET may be turned to activate the Rd, which electrically connects the electronic device 101 to another electronic device in the abnormal voltage, such that the electronic device acts as a power sink to receive power supply from the connected electronic device to be booted up and charged normally.

In reference to FIG. 5C, if the system power becomes equal to or less than a predetermined value as described above by way of example, the electronic device may control such that the pull-down resistor 572 connects to the gate (G) of the P-MOSFET to produce the pull-down resistance on the CC terminal. In this case, if the system power of the electronic device 101 becomes equal to or less than the predetermined value, a voltage of OV is induced to the gate (G) of the P-MOSFET such that the P-MOSFET is turned on. In this way, the electronic device 101 may receive power supply from another electronic device by maintaining the pull-down resistance stably even when the system power drops below a predetermined level.

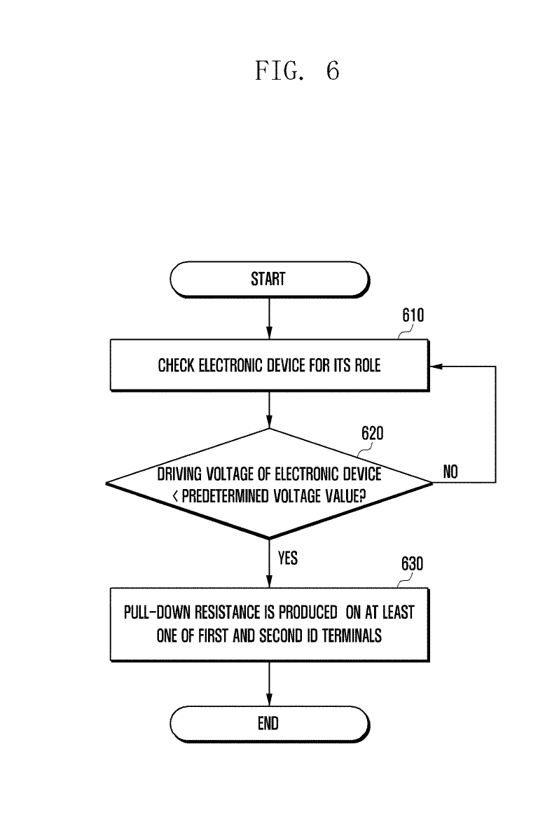

FIG. 6 is a flowchart illustrating a method for an electronic device in a low voltage state to receive power supply from another electronic device according to various embodiments.

At step 610, the electronic device 101 in the DRP mode may select its role as one of host and slave. According to various embodiments, the electronic device may communicate signals with another electronic device connected via a connector using the first ID terminal and/or the second ID terminal to determine its role based on the operation states of the electronic device 101 and the connected electronic device.

According to an embodiment, the state of the connected electronic device may include whether the pull-down resistance or pull-up resistance is configured to the first ID terminal and/or the second ID terminal of the connected electronic device. For example, if the pull-down resistance is configured to the first ID terminal and/or the second ID terminal of the connected electronic device, the electronic device 101 may take the role of host. If the pull-up resistance is configured to the first ID terminal and/or the second ID terminal of the connected electronic device, any of the two electronic devices can be the host and, in this case, the electronic device 101 may not be connected to the other electronic device and may transfer the electric current again.

At step 620, the electronic device 101 may determine whether the system power is equal to or less than a predetermined value. The predetermined voltage value may indicate the voltage level at which the electronic device 101 cannot normally operate. For example, the electronic device 101 may determine whether the system power is equal to or less than 3.0 V.

If the system power is equal to or less than 3.0 V, the electronic device 101 may configure such that the pull-down resistance is produced at the first ID terminal and/or the second ID terminal at step 630. The pull-down resistance may be changed to Rd 5.1 kΩ in order for the electronic device 101 to take the role of power sink in compliance with the USB3.1 Type-C standard by way of example. Here, the CC1 and CC2 terminals may be configured both with Rd, and the power roles of the two devices may be defined via one of the first and second ID terminals regardless of the connection direction of another electronic device as the power source. If the system power is greater than 3.0 V, the electronic device 101 continues the operation of step 610.

After the electronic device 101 is configured such that the pull-down resistance is produced at the first ID terminal and/or the second ID terminal on a predetermined condition, if another electronic device is electrically connected at step 630, the connected electronic device may supply power to the electronic device without performing any operation of determining their roles with the electronic device 101.

In detail, the another device may transfer a predetermined amount of electric current through the first ID terminal and/or the second ID terminal. For example, the another electronic device may transfer the electric current of about 330 μA. If the another electronic device detects a voltage of 1.683 produced by the electric current of 330 μA and the resistance of 5.1 KΩ on the first ID terminal and/or the second ID terminal, it may begin power supply to the electronic device 101. Although the description is made with specific values in various embodiments, the present disclosure is not limited by certain electric current, voltage, and resistance values.

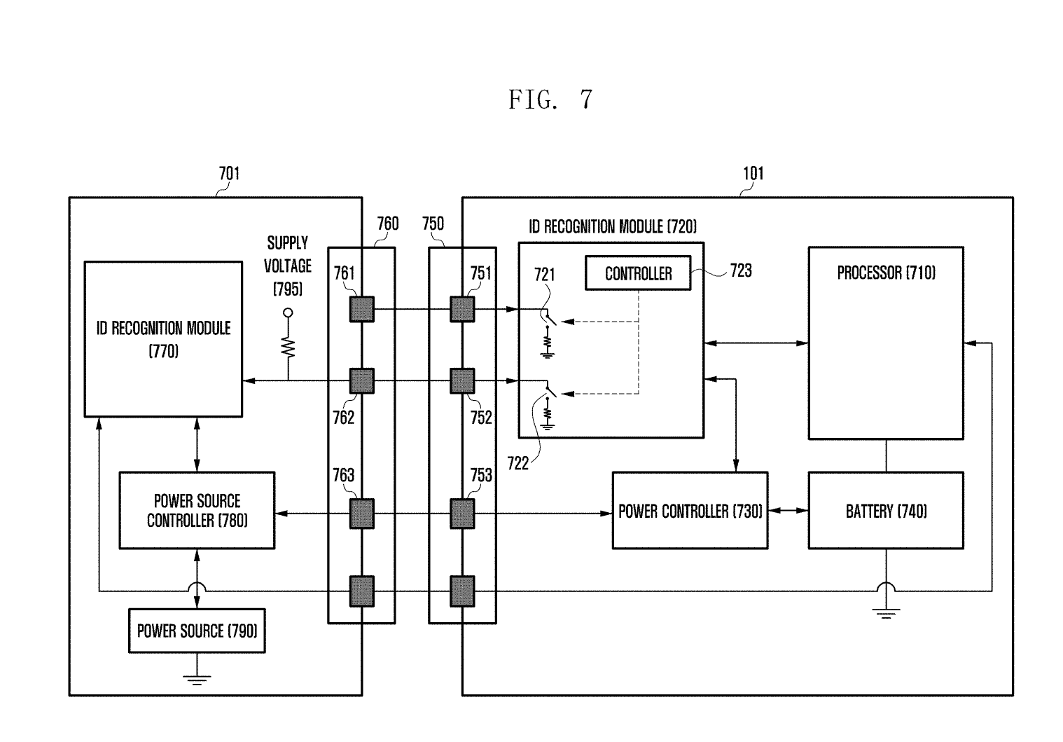

FIG. 7 is a block diagram for explaining a method for an electronic device in a low voltage state to receive power supply from another electronic device according to various embodiments.

The electronic device 101 may include a processor 710, an ID recognition module 720, an ID recognition module controller 723, a power controller 730, a battery 740, and a connector 750. The connector 750 may include a first ID terminal 751, a second ID terminal 752, and a power terminal 753. However, the configuration is not limited thereto. For example, the electronic device 101 may further include a connection detection circuit (not shown) for detecting a connection of another electronic device (not shown).

The another electronic device 701 that is electrically connected to the electronic device 101 may include an ID recognition module 770, a power source controller 780, a power source 790, and a connector 760. The connector 760 may include a first ID terminal 761, a second ID terminal 762, and a power terminal 763.

According to various embodiments, the processor 710 may check the battery 740 for voltage periodically. The processor 710 may control the ID recognition module 720 to collect information on the another electronic device 701 and the connection to the another electronic device 701.

According to various embodiments, the processor 710 may determine whether the voltage of the battery is equal to or lower than a predetermined voltage. The predetermined voltage value may indicate the voltage level at which the electronic device 101 cannot normally operate. For example, if the voltage of the battery 740 becomes equal to or less than 3.0 V, the electronic device 101 may not operate normally. In this case, the first switch 721 and/or the second switch 722 is shorted according to a control signal from the controller 723 such that the pull-down resistance remains on the first ID terminal 751 and/or the second ID terminal 752.

According to various embodiments, the controller 723 may control such that the first switch 721 and/or the second switch 722 is opened upon induction of power to the electronic device 101 and shorted upon removal of the power. If the voltage of the battery 740 becomes equal to or less than the predetermined voltage level such that the power supply to the electronic device 101 is removed, the first switch 721 and/or the second switch 722 may be shorted. As a consequence, the pull-down resistance is produced on the first ID terminal 751 connected to the first switch 721 and/or the second ID terminal 752 connected to the second switch 722.

According to various embodiments, if the total power status of the electronic device 101 becomes equal to or less than the predetermined value to stop operation of the processor 710, the ID recognition module 720 may remain in operation by itself. Accordingly, the ID recognition module 720 may check the battery 740 for the voltage at a predetermined interval. In the case where the voltage of the power input to the ID recognition module 720 from the power source of the electronic device 101 drops to be equal to or less than a predetermined level at which the ID recognition module 720 cannot operate normally, the ID recognition module 720 may fix the full-down resistance on the terminals 721 and 722 determining the power mode of the electronic device 101. This embodiment may be embodied with pull-down resistance through a switch driving circuit of a semiconductor device as described above.

According to various embodiments, the ID recognition module 720 may determine whether the voltage of the battery 720 is equal to or lower than a predetermined voltage level. For example, if the voltage of the battery 740 is equal to or less than 3.0 V, the electronic device 101 may not operate normally. In this case, the first switch 721 and/or the second switch 722 may be shorted such that the pull-down resistance remains on the first ID terminal 751 and/or the second ID terminal 751.

In the state where the pull-down resistance remains on the first switch 721 and/or the second switch 722 as described above, if the ID terminals 751 and 752 of the electronic device 101 and the ID terminals 761 and 762 of the another electronic device 701 contact each other electrically, the another electronic device 101 may supply power to the electronic device 101 with no exchange of information on host and slave roles for power supply with the electronic device 101.

The another electronic device 701 may include a detection circuit (not shown) for detecting the voltage on the ID recognition module 770. For example, the detection circuit (not show) included in the ID recognition module 770 may include a comparator circuit for measuring the voltage level.

According to various embodiments, the another electronic device 701 may supply a predetermined amount of electric current (e.g., 330 μA) to the electronic device 101 via the first ID terminal 761 and sense the voltage level on the first ID terminal 761 to determine whether the pull-down resistor is connected to the first ID terminal 751 of the electronic device 101.

For example, if the first switch of the electronic device 101 is shorted such that the first ID terminal 751 is connected to the pull-down resistor, the electric current of 330 μA coming from the another electronic device 701 flows through the first ID terminal 751 and a resistor (e.g., 5.1 kΩ) to cause a voltage drop such that a voltage of about 1.683 V may be applied to the first ID terminal 751 of the electronic device 101. The voltage at the first ID terminal 761 of the another electronic device 710 may be about 1.683 V because the first ID terminal 761 of the another electronic device 710 is connected to the first ID terminal 751 of the electronic device 101 (or shorted).

In contrast, if the first switch of the electronic device 101 is opened, there is no voltage drop caused by the pull-down resistance, and the voltage at the first ID terminal 761 of the another electronic device 710 may be less than 1.683 V in the state where the first switch is shorted. The another electronic device 701 may detect the voltage level at the first ID terminal 761 to ascertain that the pull-down resistance remains in the electronic device 101.

The another electronic device may determine whether the pull-down resistor is connected to the second ID terminal 752 of the electronic device 101, i.e., whether the second switch 722 is opened or shorted, in the same manner as described above. Although the determination on whether the pull-up resistance is applied on the first ID terminal 751 and/or the second ID terminal 752 is made with a specific method by way of example, the determination method is not limited to that described above.

According to various embodiments, the another electronic device 701 detects any change of voltage level caused by equivalent resistance subjected to the supply voltage to ascertain that the pull-down resistance remains.

Although specific voltage, current, and resistance values are disclosed in various embodiments, those values may be changed according to the characteristics of the electronic device 101 and another electronic device 701.

As described above, the another electronic device 701 may ascertain that the pull-down resistance is induced at the first ID terminal 750 and/or the second ID terminal 752 of the electrically connected electronic device 101. In this case, the another electronic device 701 may control the power source controller 780 to supply power from the power source 790 to the electronic device 101 via the power terminal 753.

According to various embodiments, upon receipt of the power supply from the another electronic device 701, the power controller 730 is activated to power on the electronic device 101 such that a charging algorithm starts running. In this case, the charging voltage and current may be varied for protecting the cells of the battery 740.

According to various embodiments, after being powered on with the power supply, the electronic device 101 may operate in a charging mode, an on-the-go (OTG) mode, and a power path mode under the control of the processor 710.

The charging mode is an operation mode for charging the battery 740 with the power input from outside. For example, the electronic device 101 may charge the battery 740 with the power input through the power terminal 753 under the control of the power controller 730. According to an embodiment, the electronic device 101 operating in the charging mode may transfer the power input from outside to the battery 740 in part and the remaining part of the power to the components (e.g., processor 710 and ID recognition module 720) of the electronic device 101 under the control of the power controller 730.

The OTG mode is an operation mode enabling the electronic device 101 to supply power to various peripheral devices such as a mouse, a keyboard, and a USB memory through a connectable interface. According to an embodiment, the electronic device 101 operating in the OTG mode may supply power from its battery 730 to another electronic device via the power terminal 753.

The power path mode is an operation mode for supplying the power input from outside to the components of the electronic device 101 without the exception of the battery 740 under the control of the power controller 730. According to an embodiment, the electronic device 101 may supply the power input from the another electronic device 701 to the power controller 730 but not to the battery 740.

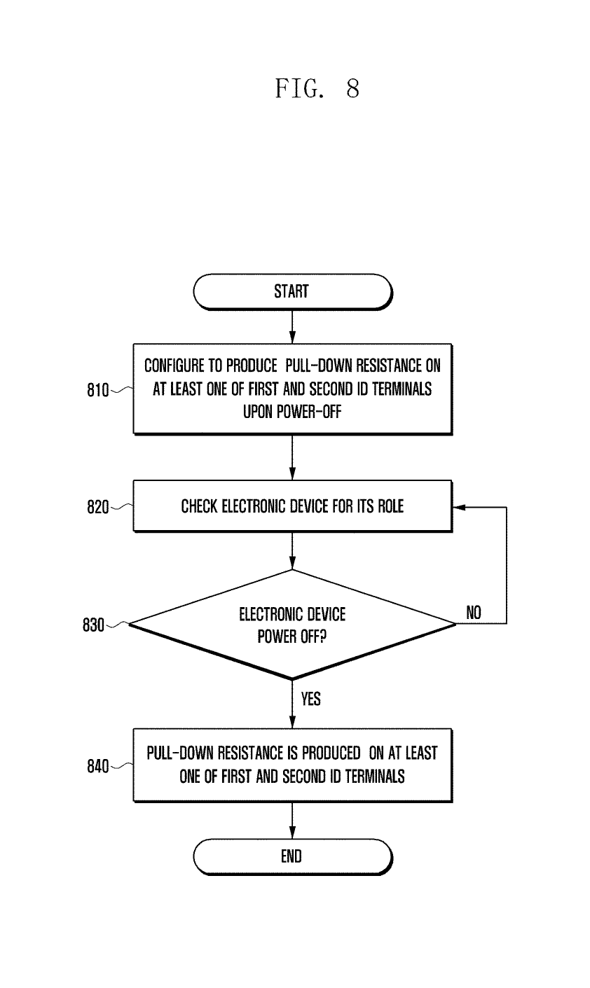

FIG. 8 is a flowchart illustrating a procedure for an electronic device in a power-off state to receive power supply from another electronic device according to various embodiments.

At step 810, the electronic device in the power-off state is configured at step 751 such that the pull-down resistance is produced on at least one of the first ID terminal 751 and the second ID terminal 752.

At step 820, the electronic device 101 may select its role as one of a host device or a slave device in the DRP mode. According to various embodiments, the electronic device 101 may communicate signals with another electronic device connected via a connector using the connector's first ID terminal 751 and/or second ID terminal 752 and determine its role based on the states of the electronic device 101 and the another electronic device.

At step 830, the electronic device 101 may determines whether it powers off. For example, although the electronic device 101 powers off, the processor does not completely stop running and may check the electronic device 101 for its state and perform operations necessary even in the power-off state. According to an alternative embodiment, a controller (e.g., controller 521 of FIG. 5 and controller 723 of FIG. 7) of the ID recognition module (e.g., ID recognition module 520 of FIG. 5 and ID recognition module 720 of FIG. 7) of the electronic device 101 may control the first switch 721 and/or the second switch 722 to be shorted and remain in short circuit before the power-off of the electronic device such that the first ID terminal 751 and/or the second ID terminal 752 is connected to a pull-up resistor.

At step 840, if it is determined that the electronic device 101 powers off, the electronic device 101 may configure such that the pull-down resistance is produced on the first ID terminal 751 and/or the second ID terminal 752. For example, if the electronic device 101 powers off, the switch connected to the first ID terminal 751 and/or the second ID terminal 752 may be shorted. As a consequence, the pull-down resistance is produced at the first ID terminal 751 and/or the second ID terminal 752. For example, the pull-down resistance may be about 5.1 KΩ. If the power is not turned off, the electronic device 101 may continue the operation of step 820.

After the electronic device 101 is configured such that the pull-down resistance is produced at the first ID terminal 751 and/or the second ID terminal 752 on a predetermined condition as at step 840, if another electronic device is electrically connected, the another electronic device may supply power to the electronic device 101 without performing any operation for determining their mutual roles.

In detail, the another electronic device may supply a predetermined amount of electric current via its first ID terminal 751 and/or second ID terminal 752. For example, the another electronic device may supply the electric current of 330 μA. If the another electronic device detects a voltage of 1.683 V produced by the product of the electric current of 330 μA and the resistance of 5.1 KΩ of the electronic device 101, it may supply power to the electronic device 101. Although the description has been made with specific values in various embodiments, the present disclosure is not limited by the electric current, voltage, and resistance values.

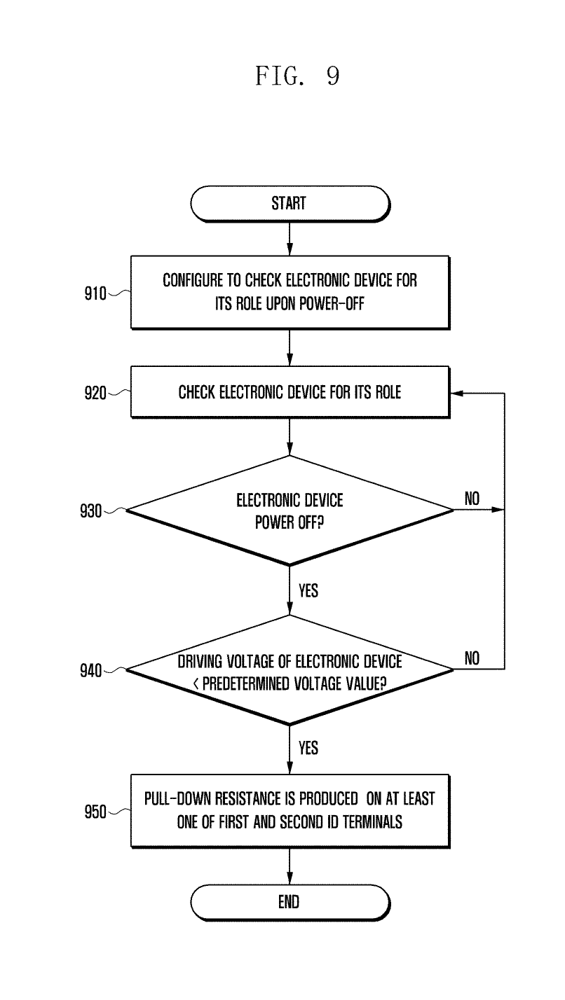

According to an embodiment of the present invention, it may be possible to configure the electronic device 101 such that no pull-down resistance is produced at the first ID terminal 751 and/or the second ID terminal 752 when the electronic device 101 powers off, unlike the operation of step 810. The operation of the electronic device 101 in such a case is made with reference to FIG. 9. Whether to fix the pull-down resistance at the first ID terminal 751 and/or the second ID terminal 752 when the electronic device 101 powers off may be determined according to user's settings, for which a GUI may be provided.

FIG. 9 is a flowchart illustrating a procedure for an electronic device in a power-off or low voltage state to receive power supply from another electronic device according to various embodiments.

At step 910, the electronic device 101 may be configured to enter a DRP mode for selecting its role as one of a host device or a slave device when it powers off.

At step 920, the electronic device 101 may select its role as one of host and slave device. According to various embodiments, the electronic device 101 may communicate signals with another electronic device connected thereto via a connector with the first ID terminal 751 and/or the second ID terminal 752 to determine its role based on its state and that of the another electronic device.

At step 930, the electronic device 101 may determine whether it powers off. For example, although the electronic device 101 power off, the processor does not completely stop running and may check the electronic device 101 for its state and perform operations necessary even in the power-off state. If the electronic device does not power off, it may perform the operation of step 920.

At step 940, the electronic device 101 may determine whether the system power is equal to or less than a predetermined value. The predetermined voltage value may indicate a voltage level at which the electronic device cannot operate normally. For example, the electronic device may determine whether the system power is equal to or less than 3.0 V.

If it is determined at step 940 that the system power is equal to or less than 3.0 V, the electronic device 101 may configure such that the pull-down resistance is produced at the first ID terminal 751 and/or the second ID terminal 752. The pull-down resistance may be about 5.1 KΩ by way of example. If the system power is greater than 3.0 V, the electronic device may continue the operation of step 920.

If it is determined that the system power is equal to or less than 3.0 V, the electronic device 101 may configure at step 950 such that the pull-down resistance is produced at the first ID terminal 751 and/or the second ID terminal 752. For example, if the electronic device 101 powers off, the switch connected to the first ID terminal 751 and/or the second ID terminal 752 may be shorted. As a consequence, the pull-down resistance may be produced at the first ID terminal 751 and/or the second ID terminal 752. The pull-down resistance may be about 5.1 KΩ by way of example. If it is determined that the system power is greater than 3.0 V, the electronic device 101 may continue the operations of step 610.

After the electronic device 101 is configured such that the pull-down resistance is produced at the first ID terminal 751 and/or the second ID terminal 752 on a predetermined condition as at step 840, if another electronic device is electrically connected, the another electronic device may supply power to the electronic device 101 without performing any operation for determining their mutual roles.

The term “module” according to the embodiments of the invention, means, but is not limited to, a unit of one of software, hardware, and firmware or any combination thereof. The term “module” may be used interchangeably with the terms “unit,” “logic,” “logical block,” “component,” or “circuit.” The term “module” may denote a smallest unit of component or a part thereof. The term “module” may be the smallest unit of performing at least one function or a part thereof.

A module may be implemented mechanically or electronically. For example, a module may include at least one of Application-Specific Integrated Circuit (ASIC) chip, Field-Programmable Gate Arrays (FPGAs), and Programmable-Logic Device known or to be developed for certain operations.

According to various embodiments of the present disclosure, the devices (e.g. modules or their functions) or methods may be implemented by computer program instructions stored in a computer-readable storage medium (e.g., memory 130). In the case that the instructions are executed by at least one processor (e.g. processor 120), the at least one processor may execute the functions corresponding to the instructions. Examples of the computer-readable storage medium may include a hard disk, a floppy disk, a magnetic medium (e.g., magnetic tape), an optical medium (e.g., CD-ROM and DVD), a magneto-optical medium (e.g., floptical disk), and an internal memory. The program commands may include the language code generated by a compiler or codes executable by an interpreter.

The module or programming module of the present disclosure may include at least one of the aforementioned components with omission of some components or addition of other components. The operations of the modules, programming modules, or other components may be executed in series, in parallel, recursively, or heuristically. Also, some operations may be executed in different order, omitted, or extended with other operations.

1. An electronic device comprising:
a connector having a first terminal and a second terminal and connectable to an external electronic device;
a battery configured to supply power to the electronic device;
a first switch connected to the first terminal; and
a second switch connected to the second terminal,
wherein at least one of the first and second switches is shorted based on at least one of a state where the electronic device powers off and a state where a voltage of the battery is equal to or less than a predetermined voltage.

2. The electronic device of claim 1, wherein pull-down resistance is produced, if the at least one of the first and second switch is shorted, at the terminal to which the shorted switch is connected.

3. The electronic device of claim 2, further comprising a processor that is electrically connected to the connector and the first and second switches, wherein the processor is configured to control, if the voltage of the battery is equal to or less than the predetermined voltage, the at least one of the first and second switches to be shorted.

4. The electronic device of claim 1, wherein the electronic device is configured to receive power supply from the external electronic device when the external electronic device is electrically connected via the connector.

5. The electronic device of claim 4, wherein the connector further comprises a third terminal for receiving the power supply from the external electronic device that is electrically connected to the electronic device.

6. A power supply system comprising:
a first electronic device having a first connector; and
a second electronic device having a second connector for electrically connecting to the first electronic device;
wherein the first electronic device is configured to maintain, if the first electronic device satisfies a predetermined condition, predetermined resistance on at least one of multiple terminals included in the first connector, and the second electronic device is configured to supply, if the first and second electronic devices are electrically connected to each other via the first and second connectors, power to the first electronic device upon detection of the resistance produced on the at least one terminal of the first electronic device.

7. The power supply system of claim 6, wherein the first electronic device further comprises a battery, and the predetermined condition is at least one of a condition where the first electronic device powers off and a condition where voltage of the battery is equal to or less than a predetermined voltage.

8. The power supply system of claim 6, wherein the first electronic device comprises a plurality of terminals included in the first connector and a plurality of switches connected to the plurality of terminals and, if at least one of the plurality of switches is shorted, pull-down resistance is produced on the terminal connected to the shorted switch.

9. The power supply system of claim 8, wherein the second electronic device is configured to detect the resistance produced on the at least one terminal of the first electronic device based on a voltage value on the at least one of a plurality of terminals included in the second connector.

10. The power supply system of claim 9, wherein the second electronic device is configured to determine, if a difference of voltage value of at least one of the plurality of terminals included in the second connector is in a predetermined range, that a resistor is connected to the at least one terminal of the first electronic device and supplies power to the first electronic device.

11. A method for controlling an electronic device including a connector having at least one terminal and at least one switch connected to the at least one terminal, the method comprising:
determining whether the electronic device takes one of roles as a host device for supplying power and a slave device for receiving the power;
determining whether one of a condition where the electronic device powers off and a condition where voltage of a battery of the electronic device is equal to or less than a predetermined voltage is satisfied; and
shorting, if at least one of the conditions is satisfied, the at least one switch.

12. The method of claim 11, wherein shorting the at least one switch comprises producing pull-down resistance on the terminal to which the at least one switch is electrically connected.

13. The method of claim 11, further comprising receiving, if an external electronic device is electrically connected via the connector, power supply from the external electronic device.

14. A power supply method of a system including a first electronic device having a first connector and a second electronic device having a second connector for electrically connecting to the first electronic device, the method comprising:
determining whether the first electronic device satisfies a predetermined condition;
producing, if the first electronic device satisfies the predetermined condition, predetermined resistance on at least one of a plurality of terminals included in the first connector; and
supplying, if the first and second electronic devices are electrically connected to each other via the first and second connectors, power from the second electronic device to the first electronic device upon detection of the resistance produced on the at least one terminal of the first electronic device.

15. A persistent recording medium storing instructions for performing a method for controlling an electronic device including a connector having at least one terminal and at least one switch connected to the at least one terminal, the instructions comprising instructions for:
determining whether the electronic device takes one of roles as a host device for supplying power and a slave device for receiving the power;
determining whether one of a condition where the electronic device power off and a condition where voltage of a battery of the electronic device is equal to or less than a predetermined voltage is satisfied; and
shorting, if at least one of the conditions is satisfied, the at least one switch.
